(19) United States
(12) Patent Application Publication
(10) Pub. No.: US 2023/0215038 A1
(43) Pub. Date: Jul. 6, 2023

(54) IMAGE PROCESSING APPARATUS, IMAGE PROCESSING METHOD, AND RECORDING MEDIUM

(71) Applicant: SONY GROUP CORPORATION, TOKYO (JP)

(72) Inventors: KAZUHIRO SHIMAUCHI, TOKYO (JP); TAKASHI KOHASHI, TOKYO (JP)

(21) Appl. No.: 17/928,548

(22) PCT Filed: May 28, 2021
(86) PCT No.: PCT/JP2021/020438

§ 371 Date: Nov. 29, 2022

(30) Foreign Application Priority Data
Jun. 11, 2020 (JP) 2020-101848

(51) Int. Cl. G06T 7/73; G06V 40/16

(52) U.S. Cl. CPC G06T 7/73; G06V 40/165

(57) ABSTRACT

The present technology relates to an image processing apparatus, an image processing method, and a recording medium capable of appropriately determining a direction in which a subject being imaged faces.

The present technology includes a detector that detects a face and a predetermined part of a subject in a captured image, a face direction determiner that determines a direction in which the face detected by the detector faces, a part direction determiner that determines a direction in which the predetermined part detected by the detector faces, and a first direction decider that decides a direction in which the subject faces by using a determination result by the face direction determiner and a determination result by the part direction determiner. The present technology can be applied to an image processing apparatus that controls framing.

### TECHNICAL FIELD

The present technology relates to an image processing apparatus, an image processing method, and a recording medium, and relates to, for example, an image processing apparatus, an image processing method, and a recording medium capable of more appropriately performing framing.

### BACKGROUND ART

Patent Document 1 describes a technology for extracting a hand portion of a person in an image and determining whether the hand is a right hand or a left hand.

### CITATION LIST

### Patent Document

Patent Document 1: Japanese Patent Application Laid-Open No. 2019-19136

### SUMMARY OF THE INVENTION

### Problems to be Solved by the Invention

For example, a method of extracting a hand portion of a person in an image and determining whether the hand is left or right, a method of performing various processing on the basis of a determination result have been proposed. In a lecture capture system or the like that records a lecture at a school such as a university and realizes participation in a lecture at a remote location, it is desired to provide a video obtained by imaging a lecturer, tracking the lecturer, and performing appropriate framing according to a position of the lecturer.

The present technology has been made in view of such a situation, and enables appropriate framing.

### Solutions to Problems

An image processing apparatus according to one aspect of the present technology includes a detector that detects a face and a predetermined part of a subject in a captured image, a face direction determiner that determines a direction in which the face detected by the detector faces, a part direction determiner that determines a direction in which the predetermined part detected by the detector faces, and a first direction decider that decides a direction in which the subject faces by using a determination result by the face direction determiner and a determination result by the part direction determiner.

An image processing method according to one aspect of the present technology includes, by an image processing apparatus, detecting a face and a predetermined part of a subject in a captured image, determining a direction in which the face having been detected faces, determining a direction in which the predetermined part having been detected faces, and deciding a direction in which the subject faces on the basis of the direction having been determined in which the face faces and the direction having been determined in which the predetermined part faces.

A recording medium according to one aspect of the present technology is a computer-readable recording medium that records a program that causes a computer to execute steps of detecting a face and a predetermined part of a subject in a captured image, determining a direction in which the face having been detected faces, determining a direction in which the predetermined part having been detected faces, and deciding a direction in which the subject faces on the basis of the direction having been determined in which the face faces and the direction having been determined in which the predetermined part faces.

In an image processing apparatus, an image processing method, and a program recorded in a recording medium according to one aspect of the present technology, a face and a predetermined part of a subject in a captured image are detected, a direction in which the face having been detected faces is determined, a direction in which the predetermined part having been detected faces is determined, and a direction in which the subject faces is decided on the basis of the direction having been determined in which the face faces and the direction having been determined in which the predetermined part faces.

Note that the image processing apparatus may be an independent apparatus or an internal block constituting one apparatus.

### BRIEF DESCRIPTION OF DRAWINGS

FIG. 1 is a diagram illustrating an example of a captured image.

FIG. 2 is a diagram illustrating a configuration of one embodiment of an image processing system to which the present technology is applied.

FIG. 3 is a diagram illustrating an internal configuration example of an image processing apparatus.

FIG. 4 is a diagram for describing skeleton data.

FIG. 5 is a diagram for describing framing.

FIG. 6 is a flowchart for describing image processing.

FIG. 7 is a diagram for describing how to determine a face orientation.

FIG. 8 is a flowchart for describing determination processing of a face orientation.

FIG. 9 is a diagram for describing how to determine a face orientation.

FIG. 10 is a diagram for describing how to determine a hand orientation.

FIG. 11 is a flowchart for describing determination processing of a left hand orientation.

FIG. 12 is a flowchart for describing determination processing of a right hand orientation.

FIG. 13 is a flowchart for describing determination processing of a left hand orientation.

FIG. 14 is a flowchart for describing determination processing of an in-frame direction.

FIG. 15 is a flowchart for describing determination processing of an inter-frame direction.

FIG. 16 is a diagram for describing framing in a vertical direction.

FIG. 17 is a diagram for describing how to determine a hand orientation in the vertical direction.

FIG. 18 is a flowchart for describing determination processing of a left hand orientation.

FIG. 19 is a flowchart for describing determination processing of a right hand orientation.

FIG. 20 is a flowchart for describing determination processing of an in-frame direction.

FIG. 21 is a flowchart for describing determination processing of an inter-frame direction.

FIG. 22 is a diagram illustrating another configuration example of the image processing apparatus.

FIG. 23 is a diagram for describing framing using an object recognition result.

FIG. 24 is a diagram for describing framing using an object recognition result.

FIG. 25 is a flowchart for describing the image processing.

FIG. 26 is a diagram for describing a case where object recognition is performed by designating an object by a user.

FIG. 27 is a diagram for describing an example of a case where framing is performed by the camera.

FIG. 28 is a diagram illustrating a configuration example of a personal computer.

### MODE FOR CARRYING OUT THE INVENTION

Hereinafter, embodiments for implementing the present technology (hereinafter referred to as embodiments) will be described.

The present technology described below can be applied to, for example, a lecture capture system or the like that captures an image of a lecture at a school such as a university and realizes listening to the lecture at a remote location. In the following description, a case where the present technology is applied to a lecture capture system will be described as an example, but the present technology can be used for other systems, for example, general systems in which a subject is imaged and an image including the imaged subject is subjected to image processing and displayed.

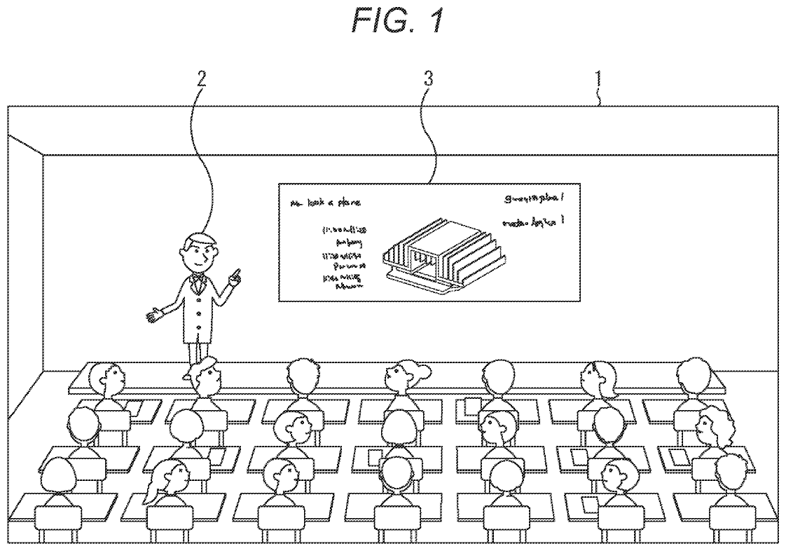

For example, an image 1 as illustrated in FIG. 1 is captured. In the image 1, a subject 2, a screen 3, and an audience are imaged. The present technology described below determines a direction in which the subject 2 faces and performs framing on the basis of the determined direction. Framing generally means that a position, a size, and the like of a frame are examined and decided in producing a photograph or a painting. Here, for example, when a region having a predetermined size is cut out from the image 1, framing means that a position and size of the region to be cut out are set.

Note that, in the following description, an image is described, but the image is a moving image and also includes a still image constituting the moving image. Furthermore, a still image constituting a moving image is appropriately referred to as a frame.

<System Configuration Example>

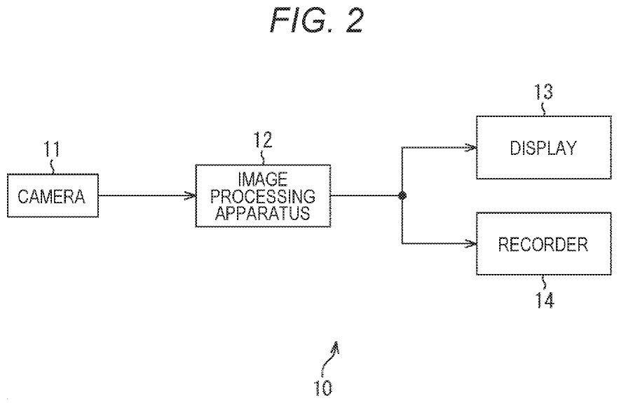

FIG. 2 is a diagram illustrating a configuration example of one embodiment of an image processing system to which the present technology is applied. An image processing system 10 includes a camera 11, an image processing apparatus 12, a display 13, and a recorder 14.

The camera 11 is an imaging device that captures the image 1 as illustrated in FIG. 1. In addition, the description will be continued on the assumption that the camera 11 is a fixed camera installed at a location where the image 1 as illustrated in FIG. 1 can be captured. Furthermore, the camera 11 can be a camera capable of capturing a relatively high-resolution image such as 4K or 8K.

The image processing apparatus 12 cuts out an image having a predetermined size from an image captured by the camera 11, and outputs the image to the display 13 or/and the recorder 14. The image processing apparatus 12 and the camera 11 may be connected via the Internet, a local area network (LAN), or the like.

Although described in detail later, when a predetermined image is cut out, the image processing apparatus 12 determines a direction in which the subject 2 faces, performs framing so as to cut out more image regions in the direction in which the subject 2 faces, and outputs the framed image to the display 13 or/and the recorder 14.

The display 13 displays the framed image from the image processing apparatus 12. Note that the display 13 may be a device such as a television receiver, or may be a device such as a projector that projects an image on a screen.

The recorder 14 records the framed image from the image processing apparatus 12 in a predetermined recording medium. The image processing apparatus 12 and the display 13, and the image processing apparatus 12 and the recorder 14 may be each connected via the Internet, a LAN, or the like.

<Configuration Example of Image Processing Apparatus>

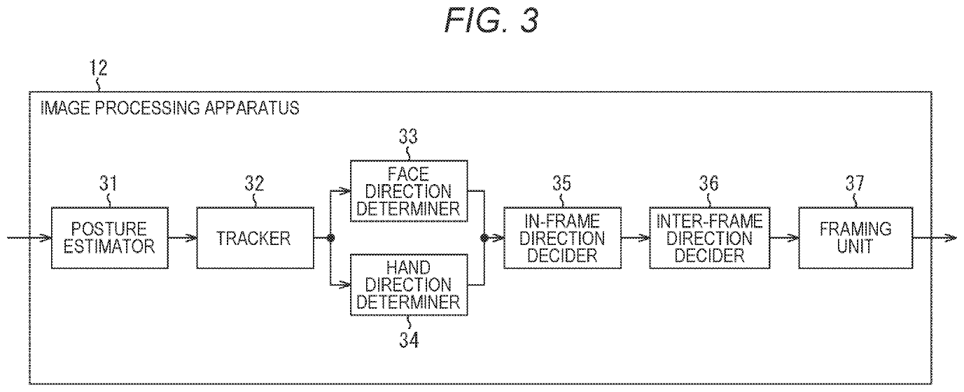

FIG. 3 is a diagram illustrating an internal configuration example of the image processing apparatus 12. The image processing apparatus 12 includes a posture estimator 31, a tracker 32, a face direction determiner 33, a hand direction determiner 34, an in-frame direction decider 35, an inter-frame direction decider 36, and a framing unit 37.

The posture estimator 31 is supplied with image data of an image captured by the camera 11, and extracts a subject captured in the image by using the image. In a case where a plurality of subjects is imaged in the image, the plurality of subjects is extracted. The posture estimator 31 performs posture estimation processing of each of the detected subjects. The posture estimation processing is, for example, processing of obtaining skeleton data of the subject as a posture of the subject.

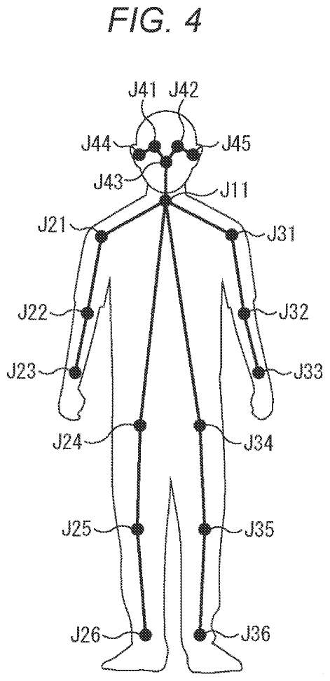

As the skeleton data, for example, skeleton data as illustrated in FIG. 4 is obtained. In FIG. 4, 18 pieces of joint information and skeleton information connecting the pieces of joint information are indicated by line segments connecting two points.

In an example in FIG. 4, joint information J11 represents the neck of a human body. Joint information J21 to J23 represent the right shoulder, the right elbow, and the right wrist of the human body, respectively, and joint information J24 to J26 represent the right hip joint, the right knee, and the right ankle of the human body, respectively. Joint information J31 to J33 represent the left shoulder, the left elbow, and the left wrist of the human body, respectively, and joint information J34 to J36 represent the left hip joint, the left knee, and the left ankle of the human body, respectively.

Furthermore, the skeleton data in FIG. 4 also includes face part information J41 to J45. The face part information J41 represents the right eye, and the face part information J42 represents the left eye. The face part information J43 represents the nose. The face part information J44 represents the right ear, and the face part information J45 represents the left ear.

The posture estimator 31 performs posture estimation processing for each subject and outputs skeleton data of the subject obtained as a result to the tracker 32. Note that a deep learning technology can be used for a posture estimation method of acquiring skeleton data as illustrated in FIG. 4, or in other words, a posture estimation method of obtaining skeleton data of a subject from a video.

Note that, here, the description will be continued on the assumption that the skeleton data as illustrated in FIG. 4 is acquired, but data of a part necessary for processing as described later is only required to be acquired. Instead of acquiring all the skeleton data illustrated in FIG. 4, only necessary skeleton data may be acquired. In addition, as a method of acquiring the skeleton data, a method other than deep learning may be used.

In the following description, for example, data of the left wrist (hereinafter, left hand) and the right wrist (hereinafter, right hand) is acquired as the skeleton data and used for processing. In addition, for example, description is made such that the left hand faces in the left direction and the face faces in the left direction.

Here, the left and right with respect to body parts of the subject such as the left hand and the right hand are the left and right directions based on the subject himself. That is, the left hand is the left hand as viewed from the subject. However, the “left direction” as in a description such that the left hand faces in the left direction is a direction in the captured image.

Reference is made again to FIG. 1. In the image 1 illustrated in FIG. 1, the subject 2 faces frontward, and the left hand of the subject 2 faces toward the screen 3. For the subject 2, the screen 3 is on the left side. However, in the image 1, the screen 3 is on the right side of the subject 2. Therefore, in this case, it is expressed that the left hand of subject 2 faces in the right direction in the image 1. In such a situation, in the following description, the left hand of the subject 2 faces in the right direction.

In such a manner, the body parts of the subject are assumed to be the left and right directions for the subject, and facing directions are assumed to be the left and right directions in the image. The direction in the image is a direction such as left or right for a viewer when viewed from the viewer. Hereinafter, the description will be continued on the basis of such a definition.

The tracker 32 tracks a subject by associating skeleton data obtained from an image set as a processing target (described as a current frame) with skeleton data obtained from an image captured at a previous time point (described as a previous frame). For example, when the skeleton data of the current frame is compared with the skeleton data of the previous frame, skeleton data in the vicinity are associated with each other.

Note that, in a case where a predetermined subject is tracked by associating skeleton data in the vicinity with each other, there is a possibility that erroneous determination is performed when a plurality of subjects intersects, for example. In order to prevent such erroneous determination, color information, for example, color information of clothes may be further used, and skeleton data may be associated with each other.

A tracking method may well be performed by a method other than the example described herein.

Note that the posture estimator 31 and the tracker 32 may perform processing only on a subject imaged in a predetermined region in the image. Furthermore, a preset subject may be detected, and tracking may be performed on the subject when such a preset subject is detected.

For example, in the image 1 illustrated in FIG. 1, it is the subject 2 that is desired to be detected and tracked as a subject. Data of the subject 2, for example, data for face authentication or the like may be registered in advance, and the subject 2 may be tracked in a case where the registered subject 2 is imaged.

Furthermore, for example, in the image 1 illustrated in FIG. 1, when it is desired to detect and track a subject (not necessarily the subject 2) in the vicinity of the screen 3, for example, an upper half region of the image 1 may be set as a processing target, and when the subject is imaged in the region, the imaged subject may be tracked.

In the following description, the description will be continued by exemplifying a case where the subject 2 in the image 1 is a tracking target.

The face direction determiner 33 determines a face direction of the subject 2 in the current frame. Processing related to the determination of the face direction will be described later. In addition, as will be described later, the description will be continued by exemplifying a case where three directions of the left direction, frontward, and the right direction are detected as the face direction.

The hand direction determiner 34 determines a hand direction of the subject 2 in the current frame. Processing related to the determination of the hand direction will be described later. In addition, as will be described later, the description will be continued by exemplifying a case where three directions of the left direction, frontward, and the right direction are detected as the hand direction. In addition, the description will be continued by exemplifying a case where the direction of each of the left hand and the right hand is detected.

Here, the description will be made by exemplifying a case where directions of three parts of the face, the left hand, and the right hand of the subject 2 are each determined. In the present technology, directions of at least two or more parts of the subject 2 are determined. Although three parts are exemplified herein, two or more parts are sufficient. In addition, as the three parts, the face, the left hand, and the right hand will be described as an example, but directions of parts other than these three parts, for example, the legs, the chest, and the abdomen may be determined.

In addition, a part that is not acquired as skeleton data may be used to determine the direction in which the part faces. For example, a part such as the breast or the abdomen may be detected, and a direction in which the breast or the abdomen faces may be determined. Furthermore, for example, information such as a line-of-sight other than parts may be used to determine a direction of the line-of-sight.

A determination result obtained by the face direction determiner 33 (hereinafter, appropriately described as a face direction determination result) and a determination result obtained by the hand direction determiner 34 (hereinafter, appropriately described as a hand direction determination result) are each supplied to the in-frame direction decider 35.

The in-frame direction decider 35 uses the face direction determination result and the hand direction determination result to determine a direction in which the subject 2 faces in the current frame. The in-frame direction decider 35 determines a direction in which the subject 2 faces in the current frame by using directions in which two or more parts of the subject 2 face respectively. A result of the in-frame direction decider 35 (hereinafter, appropriately described as an in-frame direction determination result) is output to the inter-frame direction decider 36.

The inter-frame direction decider 36 uses the in-frame direction determination result to decide a final direction in which the subject 2 faces. The inter-frame direction decider 6 finally decides a direction of the subject 2 to be used for framing in consideration of the in-frame direction determination result obtained from the current frame and a direction in which the subject faces used for framing in the previous frame, and outputs a result (hereinafter, appropriately described as an inter-frame direction determination result) to the framing unit 37.

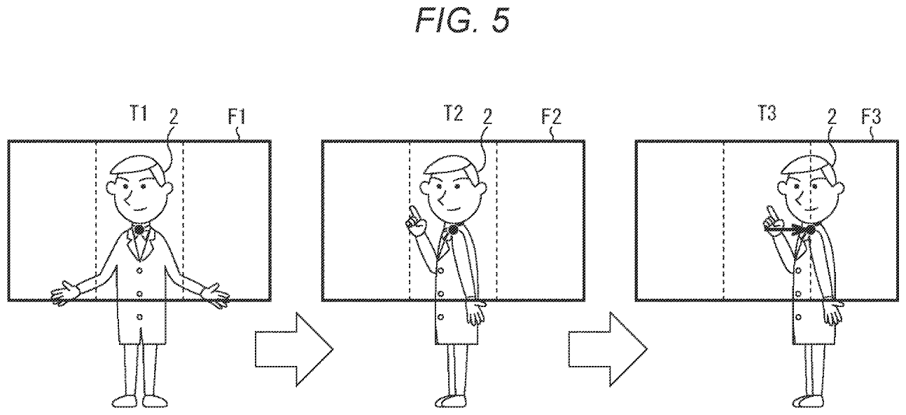

The framing unit 37 performs framing according to the direction in which the subject 2 faces by using the inter-frame direction determination result. An example of framing processing performed by the framing unit 37 will be described with reference to FIG. 5.

At time T1, an image in which the subject 2 is imaged is captured near the center of a frame F1. The frame F1 is assumed to be the framed image, that is, a result obtained by capturing the image 1 illustrated in FIG. 1 and framing a region in which the subject 2 is shown.

In FIG. 5, the frame F1 is divided into three equal parts, and dotted lines are illustrated to represent regions divided into the three equal parts. Note that, here, the description will be continued by exemplifying a case of three divisions, but the number of divisions may be any number.

In the frame F1 captured at time T1, the subject 2 faces frontward.

At time T2, when the subject 2 changes a state in which the subject 2 faces frontward to a state in which the subject 2 faces in the left direction in the drawing, this state is captured as a frame F2. Although details will be described later, in a case where the subject 2 as shown at time T2 in FIG. 5 is imaged, the face direction determiner 33 outputs a face direction determination result indicating leftward.

In addition, the hand direction determiner 34 outputs a hand direction determination result indicating that the right hand of the subject 2 faces in the left direction. Furthermore, the hand direction determiner 34 outputs a hand direction determination result indicating that the left hand of the subject 2 faces in the front direction.

In a case where such a determination result is obtained, the in-frame direction decider 35 outputs an in-frame determination result indicating that the subject 2 faces in the left direction since there are two determination results indicating that the subject 2 faces in the left direction.

Since the inter-frame direction decider 36 determines the direction of the subject 2 in consideration of the direction of the subject 2 up to the previous frame, there is a case where the inter-frame direction decider 36 does not output the determination result indicating that the subject 2 faces in the left direction at time T2. However, here, the description will be continued on the assumption that the inter-frame direction decider 36 has output the inter-frame direction determination result indicating leftward.

The framing unit 37 starts framing processing on the basis of the inter-frame direction determination result indicating leftward. In a case where the subject 2 faces the left side, for example, it can be estimated that the description is made with reference to an image captured in a region on the left side in the frame F2. That is, it can be estimated that the information of the direction in which the subject 2 faces is important, and the information with high importance is preferably displayed properly.

Therefore, framing in which more regions on the left side of the subject 2 are displayed is executed by the framing unit 37. As a result, as illustrated at time T3 in FIG. 5, framing is performed in which the subject 2 is displayed on the right side in a frame F3 and the region on the left side of the subject 2 occupies a high proportion in the frame F3.

In such a manner, framing is performed so as to make a space in the direction in which the subject 2 faces. For example, in the case described with reference to FIG. 5, since it is determined that the subject 2 faces in the left direction, framing for making a space on the left side of the subject 2 is performed. Furthermore, when it is determined that the subject 2 faces in the right direction, framing is performed so as to make a space on the right side of the subject 2.

Note that framing in which several frames are interposed is executed before a shift from the frame F2 to the frame F3. In other words, the framing processing is controlled so that framing that suddenly switches from the frame F2 to the frame F3 is not performed.

The subject 2 is displayed near the center in the frame F2. However, if framing is performed such that the subject 2 having existed near the center suddenly moves to the right side in the next frame F3, the viewer viewing such a video feels uncomfortable. Therefore, framing is performed such that the subject 2 gradually moves from around the center to the right side in the frame.

In order to perform such framing, the image processing apparatus 12 performs processing for appropriately determining the direction of the subject. To appropriately determine the direction means that, for example, in a case where the face of the subject 2 faces the left side and a hand of the subject 2 points to an object on the left side, it is determined that the subject 2 faces the left side, and the determination can be estimated to be correct, and can be an appropriate determination.

On the other hand, in a case where the face of the subject 2 faces the left side but momentarily faces the right side, it is determined that the subject 2 faces the right side, and when framing is performed, framing is performed such that an image in a direction in which the subject 2 has only momentarily focused occupies a large region. It can be said that such a direction determination is highly likely to be an inappropriate determination.

Hereinafter, the present technology capable of appropriately determining the orientation of the subject will be described.

<Processing of Image Processing Apparatus>

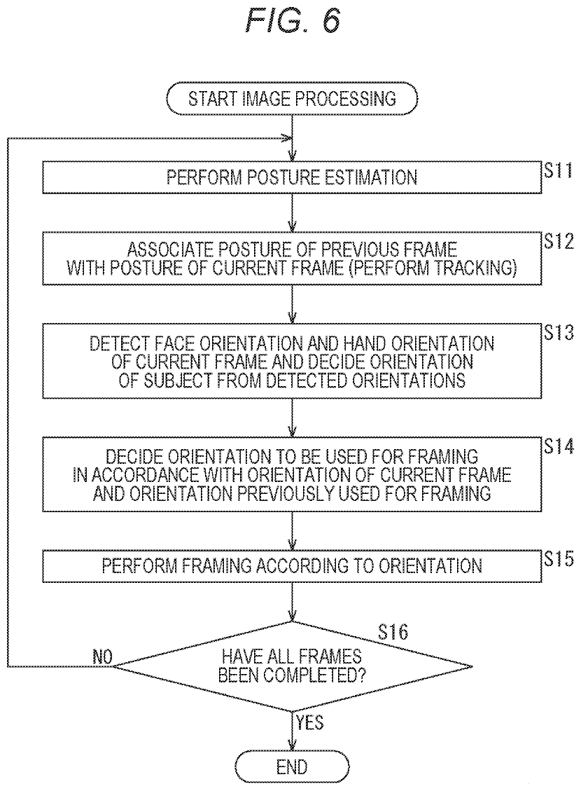

FIG. 6 is a flowchart for describing processing performed by the image processing apparatus 12 illustrated in FIG. 3. Images (frames) captured by the camera 11 (FIG. 2) are sequentially supplied to the image processing apparatus 12. The image processing apparatus 12 executes the processing of the flowchart illustrated in FIG. 6 for each supplied frame.

The image processing apparatus 12 acquires image data for one frame from the camera 11, and then performs posture estimation by the posture estimator 31 in step S11. The posture estimator 31 detects a subject from the supplied image and generates skeleton data of the subject. The generated skeleton data is the skeleton data as described with reference to FIG. 4. The skeleton data generated by the posture estimator 31 is supplied to the tracker 32.

In step S12, the tracker 32 tracks a predetermined subject (here, subject 2) by performing matching processing of skeleton data obtained in the current frame with skeleton data obtained in the previous frame.

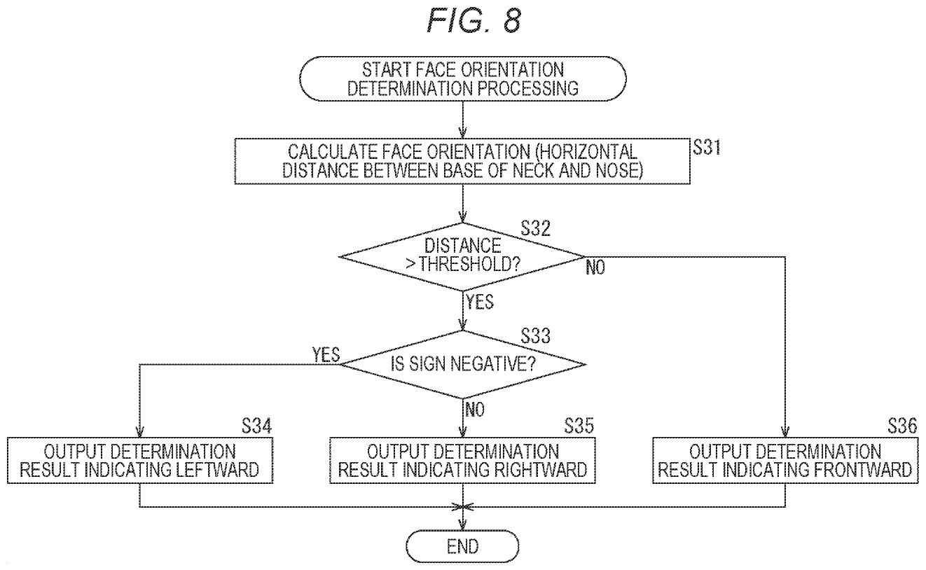

In step S13, the face direction determiner 33 determines the orientation of the face of the subject 2 and outputs the face direction determination result to the in-frame direction decider 35. Processing performed by the face direction determiner 33 will be described later with reference to a flowchart in FIG. 8.

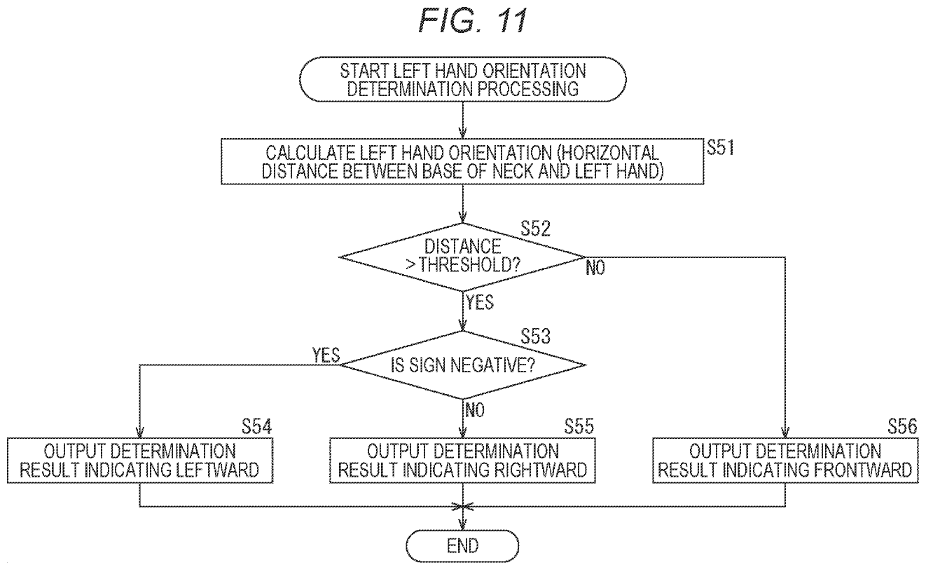

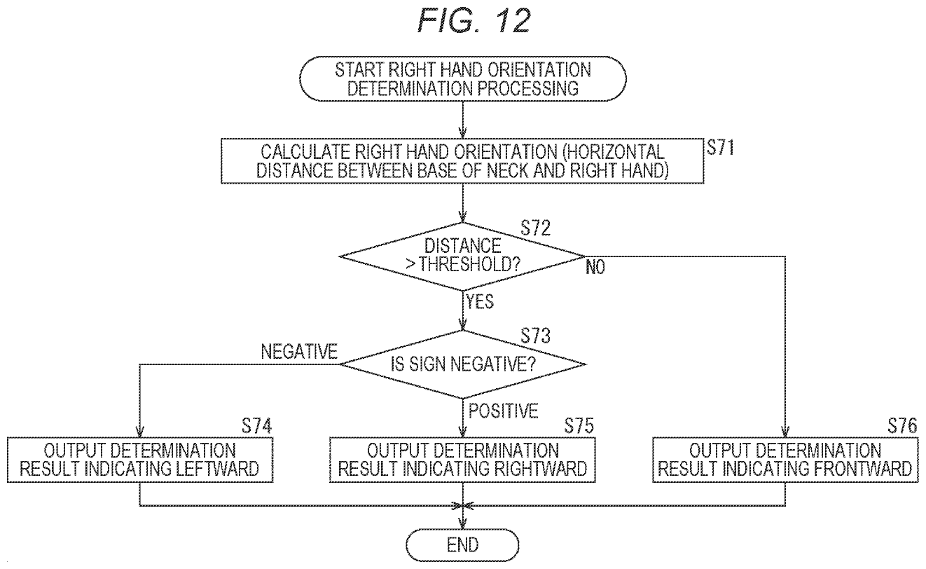

In step S13, the hand direction determiner 34 determines each of a direction in which the left hand of the subject 2 faces and a direction in which the right hand faces, and outputs the hand direction determination result to the in-frame direction decider 35. Processing performed by the hand direction determiner 34 will be described later with reference to flowcharts in FIGS. 11 and 12.

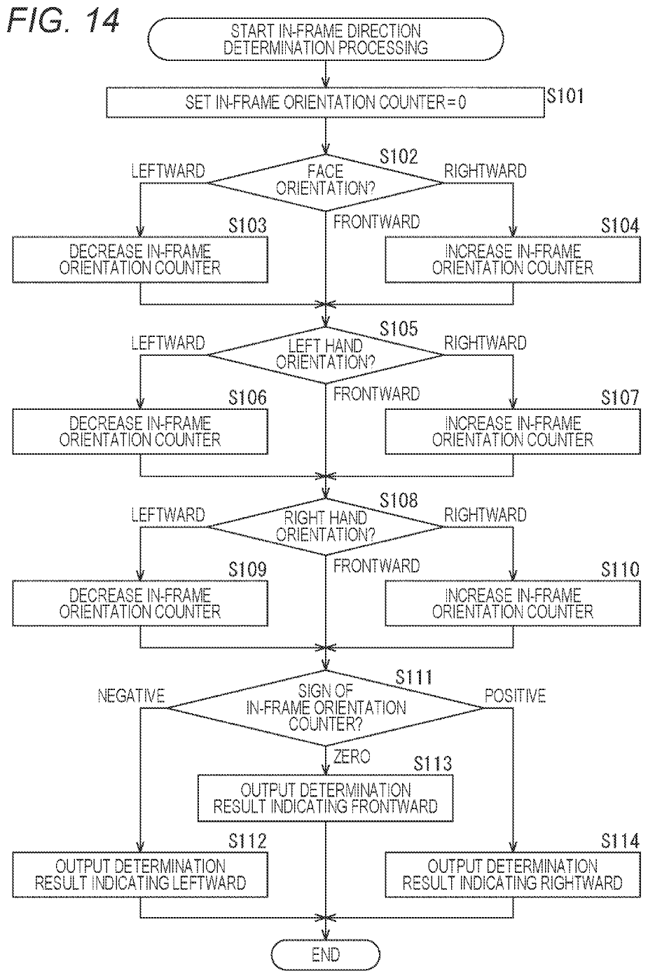

Furthermore, in step S13, the in-frame direction decider 35 determines an orientation of the subject 2 in the frame, and outputs the in-frame direction determination result to the inter-frame direction decider 36. Processing performed by the in-frame direction decider 35 will be described later with reference to a flowchart in FIG. 14.

In step S14, the inter-frame direction decider 36 receives the in-frame direction determination result in the current frame as an input, and finally decides the orientation of the subject to be used for framing in consideration of an orientation of the subject used for framing in the previous frame.

In the determination of the orientation of the subject for framing performed by the inter-frame direction decider 36, in a case where the same direction is observed for a certain number of frames, in order to smooth framing, processing of setting the direction as the inter-frame direction determination result is executed.

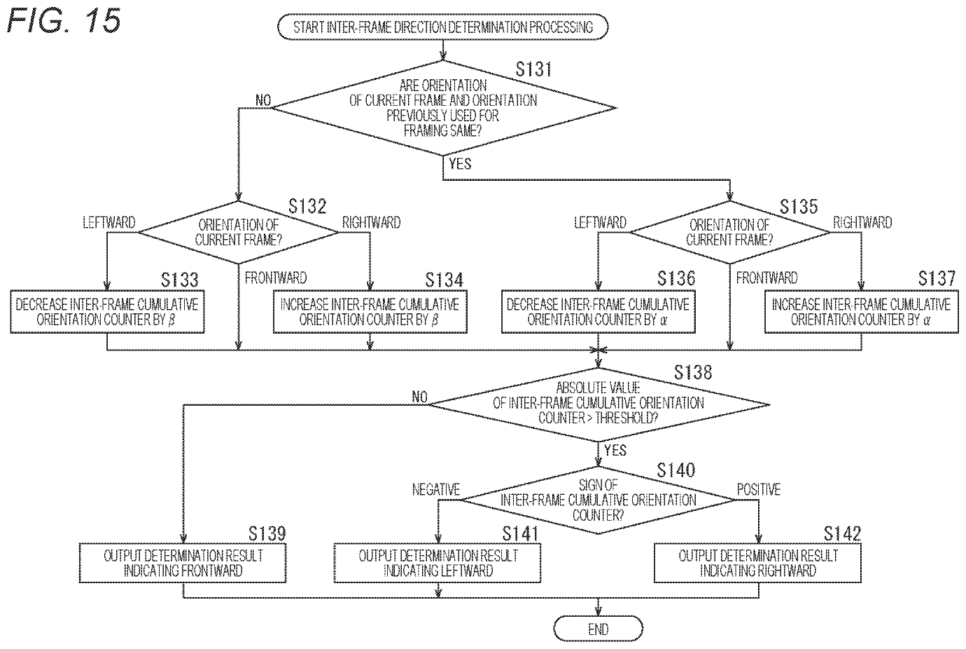

On the other hand, in a case where there is a significant change in the orientation of the subject, processing of determining the orientation earlier is executed so that framing is not left behind (does not fail to catch up). Such processing performed by the inter-frame direction decider 36 will be described later with reference to a flowchart in FIG. 15.

In step S15, the framing unit 37 receives the inter-frame direction determination result from the inter-frame direction decider 36 as an input, performs framing in accordance with the orientation, cuts out a framing video from the high-resolution video in which a bird's-eye view video is recorded, and outputs the cut-out framing video.

Here, framing is performed in accordance with the orientation of the subject 2. As described with reference to FIG. 5, for example, in a case where a determination result indicating that the subject faces in the right direction is output, a space is left in the right direction, and in a case where a determination result indicating that the subject faces in the left direction is output, a composition is made such that a space is left in the left direction, and processing for smoothly transitioning framing is executed with the composition as a target.

In step S16, it is determined whether or not the processing has been completed for all the frames. In this determination, for example, at a time point when the imaging by the camera 11 is completed, YES is determined. In a case where it is determined in step S16 that the processing has not been completed for all the frames, the processing returns to step S11, and the subsequent processing is repeated.

As described above, in the image processing apparatus 12, framing according to the direction in which the subject 2 being imaged faces is executed.

<Face Direction Determination Processing>

Face direction determining processing performed by the face direction determiner 33 will be described.

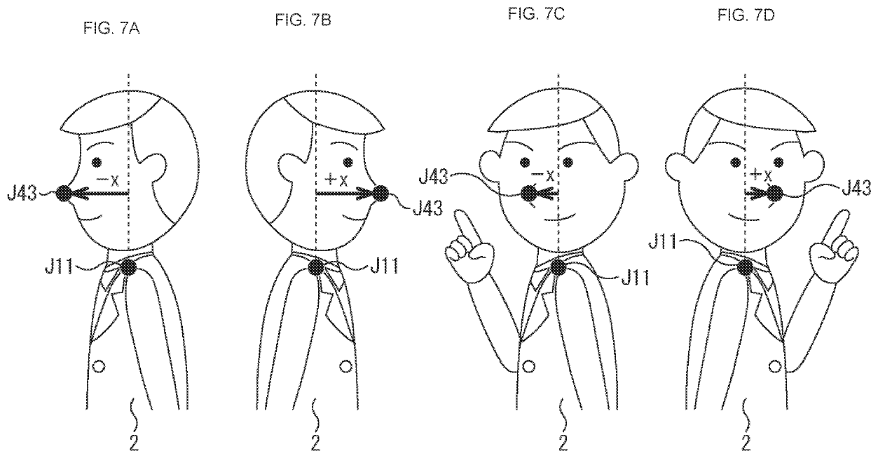

FIG. 7 is a diagram for describing how to determine the direction in which the face faces. The direction in which the face faces is determined by using the joint information J11 and the face part information J43 of the skeleton data.

Referring again to FIG. 4, the joint information J11 is information regarding the neck joint (information indicating a position of the neck). Hereinafter, the joint information J11 will be described as neck position information J11. The face part information J43 is information regarding the nose (information indicating a position of the nose). Hereinafter, the face part information J43 will be described as nose position information J43.

A of FIG. 7 is a diagram illustrating a positional relationship between the base of the neck and the nose when the subject 2 faces in the left direction. The position of the base of the neck is known from the neck position information J11. Furthermore, the position of the nose is known from the nose position information J43. A distance between the position of the base of the neck and the position of the nose in a horizontal direction is obtained.

The horizontal direction is a left-right direction in the drawing, and is also appropriately described as an X-axis direction. In addition, the description will be continued on the assumption that the left direction in the drawing is a minus side and the right direction is a plus side. The left direction in the drawing coincides with the left direction when expressed as “the subject 2 faces in the left direction”, and the right direction coincides with the right direction when expressed as “the subject 2 faces in the right direction”.

In a case where the subject 2 faces in the left direction as illustrated in A of FIG. 7, the distance from the base of the neck to the nose in the X-axis direction is −x. In a case where the subject 2 faces in the left direction, the distance between the neck and the nose takes a minus value.

On the other hand, in a case where the subject 2 faces in the right direction as illustrated in B of FIG. 7, the distance from the base of the neck to the nose in the X-axis direction is +x. In a case where the subject 2 faces in the right direction, the distance between the neck and the nose takes a plus value.

In such a manner, by obtaining the distance between the neck and the nose and determining whether the value is minus or plus, it is possible to determine whether the face of the subject 2 faces in the left direction or the right direction.

Furthermore, as illustrated in C of FIG. 7, in a case where the subject 2 slightly faces the left side, the distance between the neck and the nose becomes shorter. When A of FIG. 7 and C of FIG. 7 are compared with each other, the subject 2 in both the drawings faces in the left direction, but the distance between the neck and the nose is different. That is, how much the subject 2 faces in the left direction can be obtained from the distance between the neck and the nose.

In a similar manner, as illustrated in D of FIG. 7, in a case where the subject 2 slightly faces the right side, the distance between the neck and the nose becomes shorter. When B in FIG. 7 and D of FIG. 7 are compared with each other, the subject 2 in both the drawings faces in the right direction, but the distance between the neck and the nose is different. That is, how much the subject 2 faces in the right direction can be obtained from the distance between the neck and the nose.

As illustrated in C of FIG. 7 and D of FIG. 7, when the subject 2 slightly faces in the left or right direction, or in other words, when a distance x between the neck and the nose is other than 0, it may be determined that the subject 2 faces in the left or right direction.

However, when the subject 2 slightly faces in the left or right direction, a determination result is output that subject 2 faces in the facing direction because the subject 2 pays attention to the facing direction, and then, the determination result is highly likely to be erroneous determination. Furthermore, since the direction in which the face of the subject 2 faces is considered at a time of framing, there is a possibility that the region cut out by framing is changed when the subject 2 slightly faces the direction.

In consideration of such a situation, a threshold is provided, and when the distance x (an absolute value of the distance x) is equal to or larger than the threshold, it is determined that the subject 2 faces in the left or right direction. In a case where the absolute value of the distance x is smaller than the threshold, it can be determined that the subject 2 faces frontward by performing determination using the threshold.

The processing of the face direction determiner 33 that performs such determination will be additionally described with reference to the flowchart in FIG. 8.

In step S31, the face orientation is calculated. As described with reference to FIG. 7, the face orientation is obtained by calculating the distance between the base of the neck and the nose in the horizontal direction.

In step S32, it is determined whether or not distance>threshold is satisfied. It is determined whether or not the absolute value of the distance calculated in step S31 is larger than a predetermined threshold. As an example, the threshold can be a value set on the basis of a range of the distance x at which it is desired to determine that the subject 2 faces in the front direction. This threshold is a fixed value that is set in advance, or may be a variable value that is changeable under some condition.

In a case where the threshold is a variable value, the threshold can be a value that changes depending on a size of the subject 2 being imaged. For example, the size of the subject 2 imaged varies depending on a distance between the subject 2 and the camera 11. When the subject 2 is imaged in a state where the subject 2 is close to the camera 11, the subject 2 is imaged large, and when the subject 2 is imaged in a state where the subject 2 is far from the camera 11, the subject 2 is imaged small.

In a case where the threshold is a fixed value, and the subject 2 is imaged large, when the subject 2 slightly faces in the left direction, the distance between the neck and the nose in the horizontal direction may be equal to or larger than the threshold, and there is a possibility it is determined that the subject 2 faces in the left direction. Conversely, in a case where the subject 2 is imaged small, when the subject 2 completely faces in the left direction, the distance between the neck and the nose in the horizontal direction may be equal to or smaller than the threshold, and there is a possibility that it is determined that the subject 2 does not face the left direction, or in other words, faces in the front direction.

In consideration of such a situation, the threshold may be a threshold as a variable value set in accordance with the size of the subject 2 being imaged. Furthermore, the size of the subject 2 being imaged may be calculated by, for example, a method of estimating from a distance between the right shoulder and the left shoulder by using the joint information J21 of the right shoulder and the joint information J31 of the left shoulder of the skeleton data, or the like.

The threshold may be a fixed value, and the calculated distance x may be normalized and converted into a value independent of the imaged size, and then compared with the threshold.

In the following description as well, for example, comparison with a threshold is performed at a time of processing of determining the hand orientation, but the threshold can be set in accordance with the imaged size of the subject 2. Furthermore, processing of normalizing the distance to be calculated or the like can be included.

In a case where it is determined in step S32 that distance>threshold is satisfied, the processing proceeds to step S33. In step S33, it is determined whether or not a sign of the distance x is negative (minus).

In a case where it is determined in step S33 that the sign of the distance x is negative, the processing proceeds to step S34. In a case where the sign of the distance x is negative, the face of the subject 2 faces in the left direction as described with reference to FIG. 7. Therefore, in step S34, a determination result indicating leftward is output. This determination result is supplied to the in-frame direction decider 35 as a face direction determination result.

On the other hand, in a case where it is determined in step S33 that the sign of the distance x is not negative, or in other words, in a case where it is determined that the sign of the distance x is positive (plus), the processing proceeds to step S35. In a case where the sign of the distance x is positive, the face of the subject 2 faces in the right direction as described with reference to FIG. 7. Therefore, in step S35, a determination result indicating rightward is output. This determination result is supplied to the in-frame direction decider 35 as a face direction determination result.

On the other hand, in a case where it is determined in step S32 that distance>threshold is not satisfied, the processing proceeds to step S36. In a case where the absolute value of the distance x is smaller than the threshold, the face of the subject 2 faces in the front direction as described with reference to FIG. 7. Therefore, in step S36, a determination result indicating the front direction is output. This determination result is supplied to the in-frame direction decider 35 as a face direction determination result.

In such a manner, the direction in which the face faces is determined.

Here, as described with reference to FIGS. 7 and 8, three directions of leftward, frontward, and rightward are determined as the direction in which the face of the subject 2 faces. However, three or more directions may be determined. For example, five directions such as 90 degrees leftward (−90 degrees), 45 degrees leftward (−45 degrees), frontward (0 degrees), 45 degrees rightward (45 degrees), and 90 degrees rightward (90 degrees) may be set as a determination target.

In a case where a plurality of directions is set as a determination target, a plurality of thresholds is provided, and processing equivalent to the processing described above is performed, and then, determination results for the plurality of directions can be output. For example, in a case where distance>threshold A is satisfied, it may be determined as 90 degrees leftward or rightward, in a case where threshold A>distance>threshold B is satisfied, it may be determined as 45 degrees leftward or rightward, and in a case where threshold B>distance is satisfied, it may be determined as the front direction.

In the following description, for example, comparison with a threshold is also performed at the time of processing of determining the hand orientation, but a plurality of thresholds may be provided, and a plurality of directions (three or more directions) may be output as a determination result.

Here, as described with reference to FIG. 7, the description has been made by exemplifying a case where the direction in which the face of the subject 2 faces is determined by using the neck position information J11 and the nose position information J43 of the skeleton data. However, the direction in which the face faces may be determined by a method other than such a method.

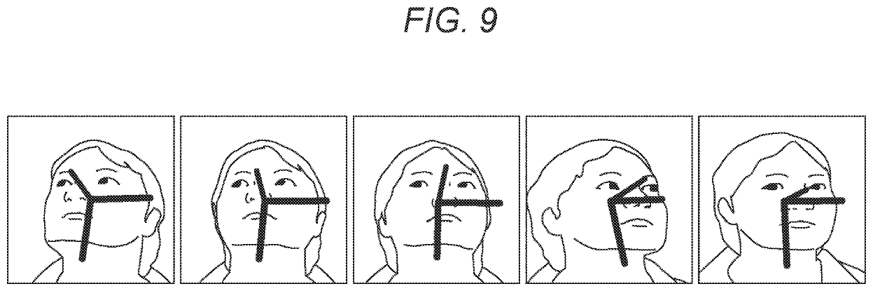

For example, the direction in which the face of the subject faces may be determined by using a deep learning technology. As illustrated in FIG. 9, in a case where the direction in which the face of the subject faces is determined using the deep learning technology, information of three axes (X axis, Y axis, and Z axis) corresponding to the face orientation is obtained.

In a case where the deep learning technology is used, the direction in which the face of the subject 2 faces can be obtained as triaxial information illustrated in FIG. 9 by analyzing the image captured by the camera 11. The face orientation may be determined by using such a technology. In addition, a machine learning technology other than the deep learning technology may be used.

Furthermore, instead of a method described later, a machine learning technology such as a deep learning technology may be used for the determination of the hand orientation described later.

<Hand Direction Determination Processing>

Hand direction determining processing performed by the hand direction determiner 34 will be described.

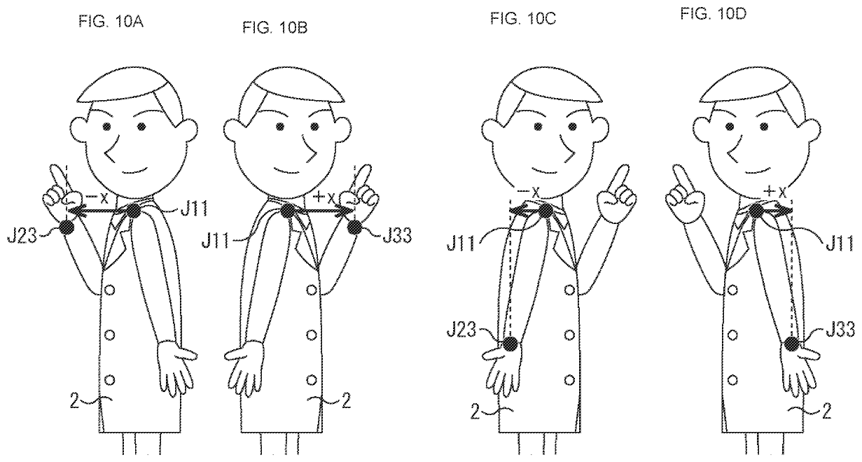

FIG. 10 is a diagram for describing how to determine the direction in which a hand faces. The direction in which the hand faces is determined by using the joint information J11, the joint information J23, and the joint information J33 of the skeleton data.

Referring again to FIG. 4, the joint information J11 is information regarding the neck joint (information indicating a position of the neck) and correspond to the neck position information J11 in the above description. The joint information J23 is information regarding the right wrist (information indicating a position of the right wrist). Hereinafter, the joint information J23 will be described as right hand position information J23. The joint information J23 is information regarding the left wrist (information indicating a position of the left wrist). Hereinafter, the joint information J33 will be described as left hand position information J33.

A of FIG. 10 is a diagram illustrating a positional relationship between the base of the neck and the right wrist when the right hand of the subject 2 faces in the left direction. The position of the base of the neck is known from the neck position information J11. Furthermore, the position of the right wrist is known from the right hand position information J23. A distance between the position of the base of the neck and the position of the right wrist in the horizontal direction is obtained.

In a case where the right hand of the subject 2 faces in the left direction as illustrated in A of FIG. 10, the distance from the base of the neck to the right wrist in the X-axis direction is −x. In a case where the right wrist of the subject 2 faces in the left direction, the distance between the neck and the right wrist takes a minus value. In A of FIG. 10, the right wrist has been described as an example, but the distance is also −x in a case where the left wrist is located on the left side.

On the other hand, in a case where the left hand of the subject 2 faces in the right direction as illustrated in B of FIG. 10, the distance from the base of the neck to the left wrist in the X-axis direction is +x. In a case where the left hand of the subject 2 faces in the right direction, the distance between the neck and the left wrist takes a plus value. In A of FIG. 10, the left wrist has been described as an example, but the distance is also +x in a case where the right wrist is located on the right side.

In such a way, by obtaining the distance between the neck and a wrist and determining whether the value is minus or plus, it is possible to determine whether a hand of the subject 2 faces in the left direction or the right direction.

As illustrated in A of FIG. 10 and B of FIG. 10, in a case where a hand of the subject 2 is away from the neck, it can be estimated that the hand is pointing something. In other words, in a case where a hand of the subject 2 is at a position away from the subject, it can be estimated that the subject 2 intentionally locates the hand at a position away from the body.

On the other hand, as illustrated in C of FIG. 10 and D of FIG. 10, the subject 2 lowers a hand when not intended, and the hand is at a position close to the body. As illustrated in C of FIG. 10, in a case where a hand of the subject 2 slightly faces the left side, the distance between the neck and the wrist becomes shorter. When A of FIG. 10 and C of FIG. 10 are compared with each other, the right hand of the subject 2 in both the drawings faces in the left direction, but the distance between the neck and the wrist is different. That is, how much the hand of the subject 2 faces in the left direction can be obtained from the distance between the neck and the wrist.

In a similar manner, as illustrated in D of FIG. 10, in a case where a hand of the subject 2 slightly faces the right side, the distance between the neck and the wrist becomes shorter. When B of FIG. 10 and D of FIG. 10 are compared with each other, the left hand of the subject 2 in both the drawings faces in the right direction, but the distance between the neck and the wrist is different. That is, how much the hand of the subject 2 faces in the right direction can be obtained from the distance between the neck and the wrist.

As described above, in the state of the subject 2 illustrated in C of FIG. 10 or D of FIG. 10, it is considered that the subject 2 does not intentionally locate the left hand or the right hand in the left direction or the right direction. In such a state, it can be said that it is not preferable processing to determine that the hand faces in the left direction or the right direction and perform framing on the basis of such a determination.

In consideration of such a situation, a threshold is provided, and when the distance x (an absolute value of the distance x) is equal to or larger than the threshold, it is determined that a hand of the subject 2 faces in the left or right direction. In a case where the absolute value of the distance x is smaller than the threshold, it can be determined that a hand of the subject 2 faces frontward by performing determination using the threshold.

The processing of the hand direction determiner 34 that performs such determination will be additionally described with reference to the flowchart in FIG. 11. Since the hand direction determiner 34 performs determination processing on each of the left hand and the right hand, the determination of the orientation of the left hand will be additionally described in the flowchart in FIG. 11.

In step S51, the hand orientation is calculated. As described with reference to FIG. 10, the hand orientation is obtained by calculating the distance between the base of the neck and the wrist of the left hand in the horizontal direction.

In step S52, it is determined whether or not distance>threshold is satisfied. It is determined whether or not the absolute value of the distance calculated in step S51 is larger than a predetermined threshold. The threshold can be a value set on the basis of a range of the distance x at which it is desired to determine that the subject 2 faces in the front direction.

This threshold is a fixed value that is set in advance, or may be a variable value that is changeable under some condition. Such a threshold may be set on the basis of the imaged size of the subject 2 in a similar manner to the case of the face orientation determination processing described above.

In a case where it is determined in step S52 that distance>threshold is satisfied, the processing proceeds to step S53. In step S53, it is determined whether or not the sign of the distance x is negative (minus).

In a case where it is determined in step S53 that the sign of the distance x is negative, the processing proceeds to step S54. In a case where the sign of the distance x is negative, the left hand of the subject 2 faces in the left direction as described with reference to FIG. 10. Therefore, in step S54, a determination result indicating that the left hand of the subject 2 is leftward is output. This determination result is supplied to the in-frame direction decider 35 as a hand direction determination result.

On the other hand, in a case where it is determined in step S53 that the sign of the distance x is not negative, or in other words, in a case where it is determined that the sign of the distance x is positive (plus), the processing proceeds to step S55. In a case where the sign of the distance x is positive, the left hand of the subject 2 faces in the right direction as described with reference to FIG. 10. Therefore, in step S55, a determination result indicating that the left hand of the subject 2 is rightward is output. This determination result is supplied to the in-frame direction decider 35 as a hand direction determination result.

On the other hand, in a case where it is determined in step S52 that distance>threshold is not satisfied, the processing proceeds to step S56. In a case where the absolute value of the distance x is smaller than the threshold, the left hand of the subject 2 faces in the front direction as described with reference to FIG. 10. Therefore, in step S56, a determination result indicating that the left hand of the subject 2 is frontward is output. This determination result is supplied to the in-frame direction decider 35 as a hand direction determination result.

In such a manner, the direction in which the left hand faces is determined.

The processing regarding the determination of the direction in which the right hand faces will be additionally described with reference to the flowchart illustrated in FIG. 12.

The processing regarding the determination of the direction in which the right hand faces is basically similar to the left hand orientation determination processing described with reference to FIG. 11, and thus the description of the processing will be omitted. However, the processing regarding the determination of the direction in which the right hand faces is different in that the distance between the base of the neck and the right hand (right wrist) in the horizontal direction is calculated in step S71 to calculate the orientation of the right hand, and the processing in and after step S71 is performed on the calculated orientation of the right hand.

Regarding the hand orientation, any of the three directions of leftward, frontward, or rightward is output as a determination result, but a plurality of thresholds may be provided, and a plurality of directions (three or more directions) may be output as a determination result.

In addition, both the processing of determining the orientation of the left hand and the processing of determining the orientation of the right hand include processing of comparing the threshold and the distance. However, the same value may be used as a threshold used in the processing of determining the orientation of the left hand (referred to as a threshold L) and a threshold used in the processing of determining the orientation of the right hand (referred to as a threshold R), or different values may be used. For example, a value that satisfies threshold L>threshold R may be set.

Furthermore, the processing of the flowcharts illustrated in FIGS. 11 and 12 is an example, and an order of the processing can be changed or another processing can be added. For example, after it is determined whether or not the sign of the distance is negative, comparison with the threshold may be performed.

For example, a case where the subject 2 moves the left hand of the subject 2 toward the right hand is considered. An action of moving the left hand toward the right hand can be regarded as an action intentionally performed by the subject 2. In a case where a video obtained by imaging the action of moving the left hand toward the right hand is viewed, the action appears as an action of moving the left hand of the subject 2 in the left direction performed by the subject 2.

In such a case, it is determined that the left hand of the subject 2 faces in the left direction, and a minus value is calculated as the distance.

In a similar manner, in a case where the subject 2 performs an action of moving the right hand of the subject toward the left hand, it is determined that the right hand of the subject 2 faces in the right direction. In a case where it is determined that the right hand of the subject 2 faces in the right direction, a plus value is calculated as the distance.

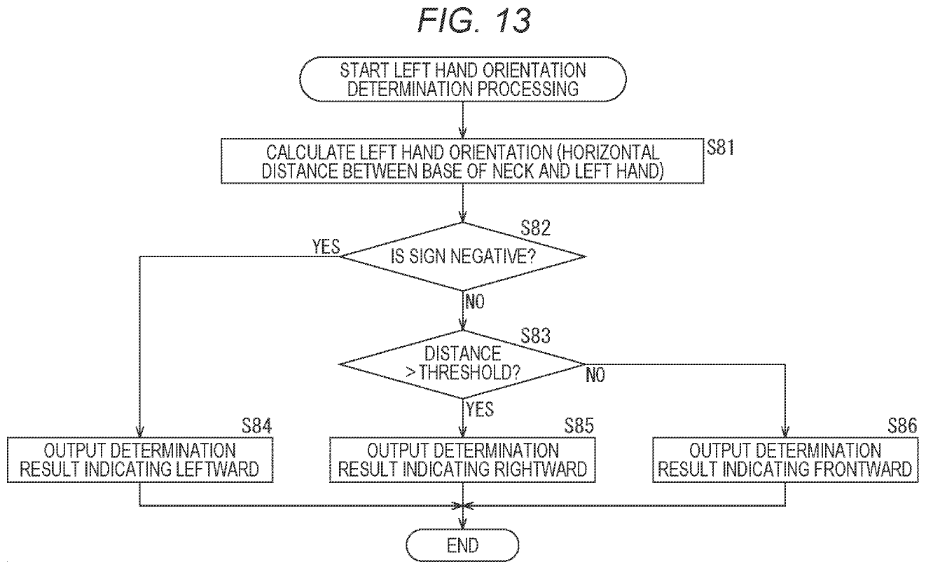

A processing flow may be provided in which, when the subject 2 intentionally moves a hand toward the hand on the opposite side, a determination result indicating the left direction or the right direction is output without performing comparison with the threshold. A case of such a processing flow will be described with reference to a flowchart illustrated in FIG. 13.

In step S81, a distance between the base of the neck and the wrist of the left hand in the horizontal direction is calculated, and thus the orientation of the left hand is calculated.

In step S82, it is determined whether or not the sign of the distance x is negative (minus). In a case where it is determined in step S82 that the sign of the distance x is negative, the processing proceeds to step S84. In step S84, a determination result indicating that the left hand of the subject 2 is leftward is output.

On the other hand, in a case where it is determined in step S82 that the sign of the distance x is not negative, or in other words, in a case where it is determined that the sign of the distance x is positive (plus), the processing proceeds to step S83.

In step S83, it is determined whether or not distance>threshold is satisfied. In a case where it is determined in step S83 that distance>threshold is satisfied, the processing proceeds to step S85. In step S85, a determination result indicating that the left hand of the subject 2 is rightward is output.

On the other hand, in a case where it is determined in step S83 that distance>threshold is not satisfied, the processing proceeds to step S86. In step S86, a determination result indicating that the left hand of the subject 2 is frontward is output.

In such a processing flow, the direction in which the left hand faces may be determined. Although not described, other processing flows regarding the determination of the direction in which the right hand faces basically can be performed in a similar manner to the other processing flow related to the determination of the direction in which the left hand faces (FIG. 13).

However, in the other processing flow regarding the determination of the direction in which the right hand faces, it is determined whether or not the sign of the distance is positive in processing corresponding to step S82, and in a case where it is determined to be positive, the determination result indicating rightward is output.

Furthermore, in the process corresponding to step S83, in a case where it is determined that distance>threshold is satisfied, a determination result indicating leftward is output.

As described above, it is also possible to appropriately replace the processing, omit the processing, or add processing, and the processing flow described here is an example and is not a description indicating limitation.

Here, as described with reference to FIG. 10, the description has been made by exemplifying a case where the direction in which a hand of the subject 2 faces is determined by using the neck position information J11 and the right hand position information J23 or the left hand position information J33 of the skeleton data. However, the direction in which the hand faces may be determined by a method other than such a method.

For example, the direction in which a hand of the subject faces may be determined by using a deep learning technology.

<Processing of In-Frame Direction Decider>

The processing performed by the in-frame direction decider 35 will be described with reference to a flowchart in FIG. 14. The in-frame direction decider 35 acquires a face direction determination result generated by the face direction determiner 33 executing the processing described above and a left hand direction determination result and a right hand direction determination result generated by the hand direction determiner 34 executing the processing described above. Then, when these determination results are acquired, the processing of the flowchart illustrated in FIG. 14 is started.

In step S101, an in-frame orientation counter is set to 0. On the basis of a value of the in-frame orientation counter, a direction in which the subject 2 faces in the frame is decided. Such a counter is set to 0, or in other words, is initialized in step S101. Since the flowchart in FIG. 14 is performed for each frame, the in-frame orientation counter is initialized to 0 when a new frame is processed.

In step S102, it is determined whether the face orientation of the subject 2 indicated by the supplied face direction determination result is leftward, frontward, or rightward.

In a case where it is determined in step S102 that the face orientation of the subject 2 indicated by the face direction determination result is leftward, the processing proceeds to step S103. In step S103, the value of the in-frame orientation counter is decreased. For example, one is subtracted from the value of the in-frame orientation counter. After the subtraction, the processing proceeds to step S105.

In a case where it is determined in step S102 that the face orientation of the subject 2 indicated by the face direction determination result is frontward, the processing proceeds to step S105. In this case, the value of the in-frame orientation counter is maintained.

In a case where it is determined in step S102 that the face orientation of the subject 2 indicated by the face direction determination result is rightward, the processing proceeds to step S104. In step S104, the value of the in-frame orientation counter is increased. For example, one is added to the value of the in-frame orientation counter. After the addition, the processing proceeds to step S105.

In step S105, it is determined whether the orientation of the left hand of the subject 2 indicated by the supplied left hand direction determination result is leftward, frontward, or rightward.

In a case where it is determined in step S105 that the orientation of the left hand of the subject 2 indicated by the left hand direction determination result is leftward, the processing proceeds to step S106. In step S106, the value of the in-frame orientation counter is decreased. For example, one is subtracted from the value of the in-frame orientation counter. After the subtraction, the processing proceeds to step S108.

In a case where it is determined in step S105 that the orientation of the left hand of the subject 2 indicated by the left hand direction determination result is frontward, the processing proceeds to step S108. In this case, the value of the in-frame orientation counter is maintained.

In a case where it is determined in step S105 that the orientation of the left hand of the subject 2 indicated by the left hand direction determination result is rightward, the processing proceeds to step S107. In step S107, the value of the in-frame orientation counter is increased. For example, one is added to the value of the in-frame orientation counter. After the addition, the processing proceeds to step S108.

In step S108, it is determined whether the orientation of the right hand of the subject 2 indicated by the supplied right hand direction determination result is leftward, frontward, or rightward.

In a case where it is determined in step S108 that the orientation of the right hand of the subject 2 indicated by the right hand direction determination result is leftward, the processing proceeds to step S109. In step S109, the value of the in-frame orientation counter is decreased. For example, one is subtracted from the value of the in-frame orientation counter. After the subtraction, the processing proceeds to step S111.

In a case where it is determined in step S108 that the orientation of the right hand of the subject 2 indicated by the right hand direction determination result is frontward, the processing proceeds to step S111. In this case, the value of the in-frame orientation counter is maintained.

In a case where it is determined in step S108 that the orientation of the right hand of the subject 2 indicated by the right hand direction determination result is rightward, the processing proceeds to step S110. In step S110, the value of the in-frame orientation counter is increased. For example, one is added to the value of the in-frame orientation counter. After the addition, the processing proceeds to step S111.

Note that an example in which the value of the in-frame orientation counter is subtracted or added by one has been described, but the value to be subtracted or added is not limited to one. Furthermore, for example, the face orientation may be processed with a weight given to the face orientation rather than the hand orientation. In such a case, for example, the value subtracted in step S103 may be a value larger than the values subtracted in steps S106 and S109. Similarly, for example, the value added in step S104 may be a value larger than the values added in steps S106 and S109.

In step S111, it is determined whether a sign of the in-frame orientation counter is negative (minus), 0, or positive (plus).

In a case where it is determined in step S111 that the sign of the in-frame orientation counter is negative (minus), the processing proceeds to step S112. In step S112, the determination result indicating leftward is output to the inter-frame direction decider 36 as the in-frame direction determination result.

In a case where it is determined in step S111 that the sign of the in-frame orientation counter is 0, the processing proceeds to step S113. In step S113, the determination result indicating frontward is output to the inter-frame direction decider 36 as the in-frame direction determination result.

In a case where it is determined in step S111 that the sign of the in-frame orientation counter is positive (plus), the processing proceeds to step S114. In step S114, the determination result indicating rightward is output to the inter-frame direction decider 36 as the in-frame direction determination result.

In such a manner, the direction in which the subject 2 faces in the frame is decided. Here, the description has been made by exemplifying a case where the respective directions of three parts of the face, the left hand, and the right hand are used. However, for example, the directions of four parts or five parts may be used, and the orientation of the subject 2 in the frame may be decided by adding basically similar processing to the processing described above.

<Processing of Inter-Frame Direction Decider>

The processing performed by the inter-frame direction decider 36 will be described with reference to a flowchart in FIG. 15. The inter-frame direction decider 36 acquires the in-frame direction determination result generated by executing the processing described above by the in-frame direction decider 35. Then, when the in-frame direction determination result is acquired, the processing of the flowchart illustrated in FIG. 15 is started.

In step S131, it is determined whether or not the current orientation of the frame is the same as an orientation previously used for framing. The current orientation of the frame is information acquired from the in-frame direction determination result. The orientation previously used for framing is the direction decided by the inter-frame direction decider 36 at a time point before (immediately before) this processing is started, that is, the inter-frame direction determination result.

The processing of step S131 is processing of determining whether or not a direction decided as the inter-frame direction determination result at a current time point coincides with a direction indicated by a newly input in-frame direction determination result.

In a case where it is determined in step S131 that the current orientation of the frame is not the same as the orientation previously used for framing, the processing proceeds to step S132. In step S132, it is determined whether the orientation of the current frame (the orientation indicated by the in-frame direction determination result) is leftward, frontward, or rightward.

In a case where it is determined in step S132 that the orientation of the current frame is leftward, the processing proceeds to step S133. In step S133, a value of an inter-frame cumulative orientation counter is decreased by β.

β is a coefficient, and a predetermined value is set for β. In addition, α described later is also a coefficient, and a predetermined value is set for α. The coefficient α and the coefficient β have a relationship satisfying coefficient α<coefficient β. For example, the coefficient α is set to 1, and the coefficient β is set to 2.

The inter-frame cumulative orientation counter is a counter which the coefficient α or the coefficient β is added to or subtracted from by repeating the processing of the flowchart in FIG. 15, and is a counter having a value obtained by cumulatively adding values obtained by processing a plurality of frames.

In step 133, when the value of the inter-frame cumulative orientation counter is subtracted by the coefficient β, the processing proceeds to step S138.

In a case where it is determined in step S132 that the orientation of the current frame is frontward, the processing proceeds to step S138. In this case, the value of the inter-frame cumulative orientation counter is maintained.

In a case where it is determined in step S132 that the orientation of the current frame is rightward, the processing proceeds to step S134. In step S134, a value of an inter-frame orientation counter is increased by the coefficient β. After the addition, the processing proceeds to step S138.

On the other hand, in a case where it is determined in step S131 that the current orientation of the frame is the same as the orientation previously used for framing, the processing proceeds to step S135. In step S135, it is determined whether the orientation of the current frame (the orientation indicated by the in-frame direction determination result) is leftward, frontward, or rightward.

In a case where it is determined in step S135 that the orientation of the current frame is leftward, the processing proceeds to step S136. In step S136, a value of an inter-frame cumulative orientation counter is decreased by the coefficient α. After the subtraction, the processing proceeds to step S138.

In a case where it is determined in step S135 that the orientation of the current frame is frontward, the processing proceeds to step S138. In this case, the value of the inter-frame cumulative orientation counter is maintained.

In a case where it is determined in step S135 that the orientation of the current frame is rightward, the processing proceeds to step S137. In step S137, a value of an inter-frame orientation counter is increased by the coefficient α. After the addition, the processing proceeds to step S138.

In step S138, it is determined whether or not an absolute value of the inter-frame cumulative orientation counter is larger than a threshold. In a case where it is determined in step S138 that the absolute value of the inter-frame cumulative orientation counter is not larger than the threshold, or in other words, in a case where it is determined that the absolute value of the inter-frame cumulative orientation counter is smaller than the threshold, the processing proceeds to step S139.

In step S139, the inter-frame direction determination result indicating that the direction in which the subject 2 faces is frontward is output to the framing unit 37.

On the other hand, in a case where it is determined in step S138 that the absolute value of the inter-frame cumulative orientation counter is larger than the threshold, the processing proceeds to step S140. In step S140, it is determined whether a sign of the inter-frame cumulative orientation counter is negative or positive.

In a case where it is determined in step S140 that the sign of the inter-frame cumulative orientation counter is negative, the processing proceeds to step S141. In step S141, the inter-frame direction determination result indicating that the direction in which the subject 2 faces is leftward is output to the framing unit 37.

On the other hand, in a case where it is determined in step S140 that the sign of the inter-frame cumulative orientation counter is positive, the processing proceeds to step S142. In step S142, the inter-frame direction determination result indicating that the direction in which the subject 2 faces is rightward is output to the framing unit 37.

In such a manner, the direction in which the subject 2 used for framing faces is finally decided. The framing unit 37 performs framing based on the inter-frame direction determination result from the inter-frame direction decider 36. The framing performed by the framing unit 37 has been described with reference to FIG. 5, and thus the description of the framing is omitted here.

The processing based on the flowchart illustrated in FIG. 15 is performed by the inter-frame direction decider 36, and the framing unit 37 executes the framing processing on the basis of the decided direction. Thus, for example, it is possible to prevent the cut-out region from switching back and forth. For example, in a case where the processing described above is not performed, even when the orientation of the subject 2 is momentarily changed, the framing is switched, and thus, there is a possibility that an image may switch back and forth.

Executing the processing described above can prevent an image from switching back and forth in such a way.

On the other hand, in a case where the image is prevented from switching back and forth, when the subject 2 intentionally changes the direction instead of changing the orientation momentarily, the change in the direction cannot be coped with, and there is a possibility that framing may be left behind (fail to catch up).

For example, in a case where the subject 2 changes the orientation and continues to move in the direction of the orientation, there is a possibility that the subject 2 is framed out if the change in the orientation cannot be coped with, and framing is maintained. By executing the processing described above, the processing can be performed so as to prevent framing from being left behind. Such a matter will be additionally described.

As described above, the value of the inter-frame cumulative orientation counter varies by adding or subtracting the coefficient α or the coefficient β. The coefficient α and the coefficient β have a relationship satisfying coefficient α<coefficient β. That is, a change in the value of the inter-frame cumulative orientation counter when the coefficient α is added or subtracted is smaller than a change in the value of the inter-frame cumulative orientation counter when the coefficient β is added or subtracted.

The processing proceeds from step S131 to step S132 in a case where the direction in which the subject 2 faces in the current frame is different from the direction in which the subject 2 faces in the frames before the current frame. That is, the processing proceeds when the direction in which the subject 2 faces is changed.

When the direction in which the subject 2 faces is changed, processing is executed in which the inter-frame cumulative orientation counter is subtracted by the coefficient β in step S133, or the inter-frame cumulative orientation counter is added by the coefficient β in step S134.

That is, when the direction in which the subject 2 faces is changed, processing is executed such that the value of the inter-frame cumulative orientation counter changes greatly. Therefore, when the direction in which the subject 2 faces is changed, processing for coping with the change can be executed.

In a case where the subject 2 faces in a predetermined direction, for example, the right direction, when the processing of the flowchart illustrated in FIG. 15 is executed, the value of the inter-frame cumulative orientation counter increases in a plus direction. Then, in a case where the orientation of the subject 2 is changed from the right direction to the left direction, processing of subtracting the coefficient β from the inter-frame cumulative orientation counter is executed.

In a case where the subject 2 momentarily changes the direction leftward, the number of times of subtraction of the coefficient β is small, and thus the value of the inter-frame cumulative orientation counter that has increased in the plus direction changes within a plus range. Therefore, in a case where the orientation of the subject 2 momentarily changes leftward, the determination result indicating that the direction of the subject 2 is rightward is continued.

On the other hand, in a case where the subject 2 changes the direction leftward and continuously faces in the left direction (for several frames), the number of times the coefficient β is subtracted increases, and thus the value of the inter-frame cumulative orientation counter that has increased in the plus direction gradually shifts to a minus range. In addition, since the value of the coefficient β is set to be larger than the coefficient α, a speed of shifting toward the minus range is fast, and the value can be shifted to the minus range at an early stage. Therefore, in a case where the subject 2 continuously changes the direction leftward, it is possible to output a determination result indicating leftward as the orientation of the subject 2 at a relatively early stage.

On the other hand, the processing proceeds from step S131 to step S135 in a case where the direction in which the subject 2 faces in the current frame is the same as the direction in which the subject 2 faces in the frames before the current frame. That is, the processing proceeds when the direction in which the subject 2 faces is not changed.

When the direction in which the subject 2 faces is not changed, processing is executed in which the inter-frame cumulative orientation counter is subtracted by the coefficient α in step S136, or the inter-frame cumulative orientation counter is added by the coefficient α in step S137.

When the direction in which the subject 2 faces is maintained, the value of the inter-frame cumulative orientation counter is controlled so as not to change greatly.

From the above description, it can be said that processing is executed such that the value of the inter-frame cumulative orientation counter greatly changes when the direction in which the subject 2 faces is changed, and processing is executed such that the value of the inter-frame cumulative orientation counter slightly changes when the orientation of the subject 2 is not changed.

Therefore, in a case where the change in the orientation of the subject 2 is momentary, the orientation of the subject 2 is not determined to be changed. On the other hand, in a case where the orientation of the subject 2 is changed and the changed direction continues, processing for coping with the change can be executed at an early stage.

Furthermore, in a case where the subject 2 wobbles left and right, processing is executed such that the sign of the value of the inter-frame cumulative orientation counter is canceled with minus and plus. Therefore, in step S138, it is determined whether or not the absolute value of the inter-frame cumulative orientation counter is larger than the threshold, but since the value of the inter-frame cumulative orientation counter is unlikely to exceed the threshold, there is a high possibility that the determination of the frontward is made. Therefore, in a case where the subject 2 wobbles left and right, it is possible to prevent a determination result indicating leftward or rightward from being output.

As described above, the present technology enables detection of a significant change in the orientation of the subject 2. Furthermore, when there is a significant change in the orientation of the subject 2, processing following the change can be executed.

An upper limit may be set to the value of the inter-frame cumulative orientation counter. When the subject 2 continues to face in the same direction, the value of the inter-frame cumulative orientation counter increases. If 1000 frames are processed in a case where all the 1000 frames are in the same direction and the coefficient α is 1, the inter-frame cumulative orientation counter has a value of 1000 (or minus 1000).

At such a numerical value, in a case where the subject 2 changes the orientation and the coefficient β is set to 2, unless the subject 2 maintains the direction of the changed orientation for 500 frames, the value of the inter-frame cumulative orientation counter does not become 0, and the direction used for framing does not change.

In a case where the inter-frame cumulative orientation counter is not provided with an upper limit, when the subject 2 changes the orientation, there is a possibility that the change cannot be detected for a while. Therefore, the inter-frame cumulative orientation counter is provided with an upper limit, and processing of maintaining the value of the inter-frame cumulative orientation counter may be performed in a case where the inter-frame cumulative orientation counter is equal to or larger than the upper limit value.

In addition, instead of providing the inter-frame cumulative orientation counter with an upper limit, the number of frames accumulated as the inter-frame cumulative orientation counter may be provided with a limit. For example, the number of frames accumulated as the inter-frame cumulative orientation counter may be set to 100 before the current frame.

In a case where the number of frames is limited to 100, it is possible to prevent the value of the inter-frame cumulative orientation counter from becoming larger than 100 (or minus 100) even if the subject 2 faces in a predetermined direction for 100 frames or more. This case can be handled substantially in a similar manner to the case where the upper limit is set to the inter-frame cumulative orientation counter.

Furthermore, in a case where the number of frames is limited as the inter-frame cumulative orientation counter, the value of the inter-frame cumulative orientation counter may be calculated by weighted addition. For example, the determination result obtained from the frame temporally close to the current frame may be weighted so as to affect the value of the inter-frame cumulative orientation counter more than the determination result obtained from the frame temporally far from the current frame.

As described above, in the image processing apparatus 12, the direction in which the subject 2 faces is detected, and framing based on the detected direction is performed.

<Determination in Vertical Direction>

The above embodiment has been described by exemplifying a case where the orientation of the subject 2 in the horizontal direction (left-right direction) is detected. Next, a case where the orientation of the subject 2 in the vertical direction (up-down direction) is detected will be additionally described.

Basic processing of detecting the orientation of the subject 2 in the vertical direction (up-down direction) described below is similar to the case of detecting the orientation of the subject 2 in the horizontal direction (left-right direction) described above, and thus the description of the basic processing is appropriately omitted. Furthermore, in a case where the description is omitted, the matters described as the above embodiment can be still applied to the following embodiment.

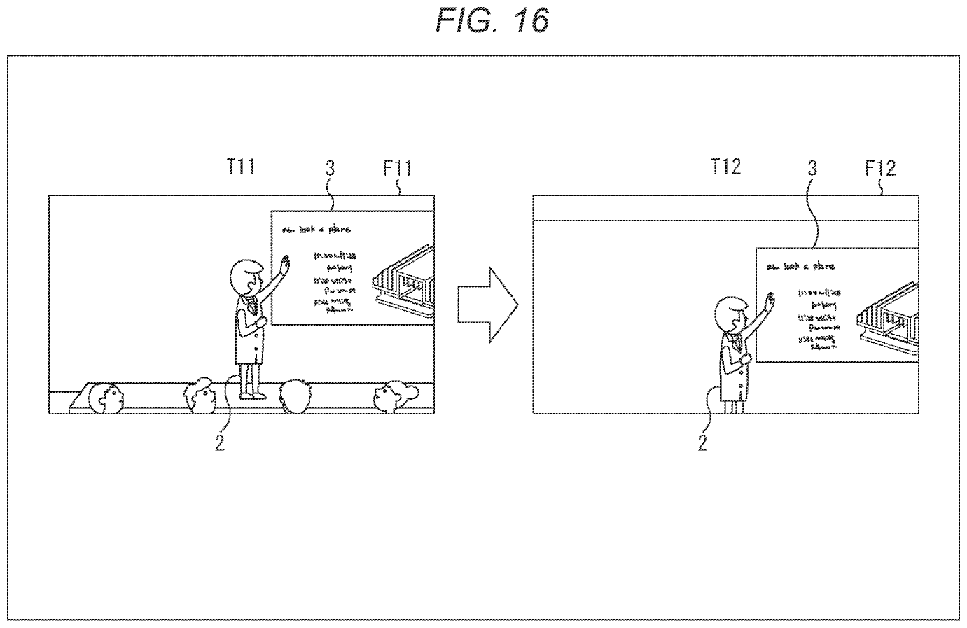

FIG. 16 is a diagram illustrating an example of framing in the up-down direction as the direction in which the subject 2 faces.

In a frame F11 captured at time T11, the subject 2 faces in the right direction in the drawing. The face of the subject 2 faces in an upper right direction, and the left hand of the subject 2 also faces in the upper right direction. In such a state of the subject 2, the processing described below is executed, and then, it is determined that the subject 2 faces in an upper direction in the vertical direction.

In a case where it is determined that the subject 2 faces in the upper direction in the vertical direction and framing is performed on the basis of the determination, the image is switched to an image illustrated as a frame F12 at time T12.

The frame F12 and the frame F11 are compared. The subject 2 imaged in the frame F11 shows the entire body, but the composition is changed such that the subject 2 imaged in the frame F12 shows a portion above the knee. In addition, the screen 3 in the frame F11 is displayed on the right side in the frame F11 on an upper side, but the composition is changed such that the screen 3 in the frame F12 is displayed on the right side in the frame F11 at the center.

Each of the frame F11 and the frame F12 is, for example, an image cut out from an image when a lecture scene illustrated in FIG. 1 is imaged. Since a region located on the upper side as compared with the region cut out as the frame F11 is cut out as the frame F12, an image in which a difference described above occurs is obtained. That is, in the example illustrated in FIG. 16, since the subject 2 faces toward the upper side, the composition is changed such that a proportion of a region located on the upper side of the subject 2 in the frame increases.

In such a manner, in a case where it is determined that the orientation of the subject 2 is above, framing for making a space above is performed. Furthermore, in a case where it is determined that the orientation of the subject 2 is below, framing for making a space below is performed. The processing performed by the image processing apparatus 12 when attention is paid to the orientation of the subject 2 in the up-down direction as described above will be further described.

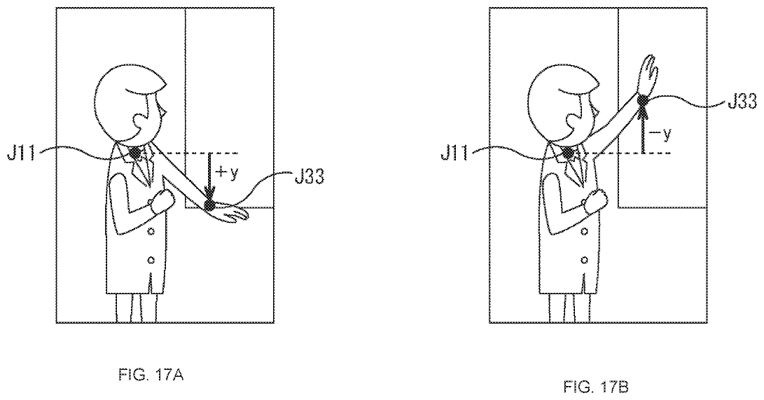

FIG. 17 is a diagram for describing how to determine the direction in which a hand faces in the up-down direction (vertical direction). The direction in which a hand faces is determined by using the joint information J11 (neck position information J11), the joint information J23 (right hand position information J23), and the joint information J33 (left hand position information J33) of the skeleton data.

The determination of a hand orientation in the vertical direction can be basically performed in a similar manner to the determination of a hand orientation in the horizontal direction (left-right direction) described with reference to FIG. 10. In the determination of the hand orientation in the horizontal direction (left-right direction) described with reference to FIG. 10, the distance between the neck and the hand in the horizontal direction is calculated. However, in a case of determining the hand orientation in the vertical direction, a distance between the neck and the hand in the vertical direction is calculated.

Here, a case where the left hand faces in the upper direction or a lower direction will be described as an example. A of FIG. 17 is a diagram illustrating a positional relationship between the base of the neck and the left wrist when the left hand of the subject 2 faces in the lower direction. The position of the base of the neck is known from the neck position information J11. Furthermore, the position of the left wrist is known from the left hand position information J33. A distance between the position of the base of the neck and the position of the left wrist in the vertical direction is obtained.

In a case where the left hand of the subject 2 faces in the lower direction as illustrated in A of FIG. 17, the distance from the base of the neck to the left wrist in the Y-axis direction is +y. In a case where the left wrist of subject 2 faces in the lower direction, the distance between the neck and the left wrist takes a plus value (here, the description will be continued on the assumption that such setting is performed). In A of FIG. 17, the left wrist has been described as an example, but the distance is also +y in a case where the right wrist is located on a lower side.

On the other hand, in a case where the left hand of the subject 2 faces in the upper direction as illustrated in B of FIG. 17, the distance from the base of the neck to the left wrist in the Y-axis direction is −y. In a case where the left hand of the subject 2 faces in the upper direction, the distance between the neck and the left wrist takes a minus value. In B of FIG. 17, the left wrist has been described as an example, but the distance is also −y in a case where the right wrist is located on the upper side.

In such a manner, by obtaining the distance between the neck and a wrist and determining whether the value is minus or plus, it is possible to determine whether a hand of the subject 2 faces in the upper direction or the lower direction.

An orientation of the face of subject 2 in the vertical direction can be obtained by processing basically similar to the processing for obtaining the orientation of the hand in the vertical direction. Furthermore, in the determination of the orientation of the face in the horizontal direction described with reference to FIG. 7, the orientation can be obtained by replacing the horizontal direction with the vertical direction. That is, the face orientation can be determined by calculating the distance from the base of the neck to the nose in the vertical direction by using the neck position information J11 and the nose position information J43.

However, the distance from the base of the neck to the nose in the vertical direction is shorter when the face faces down, and is longer when the face faces up. In order to match with the determination processing of the hand orientation, processing of converting the calculated distance may be included so that the calculated distance becomes a plus value when the face faces downward and the calculated distance becomes a minus value when the face faces upward.

Alternatively, the orientation of the face in the vertical direction may be obtained by using the deep learning technology described with reference to FIG. 9.

<Processing of Image Processing Apparatus>

In a case where the direction in which the subject 2 faces in the vertical direction is determined and framing is performed, the configuration of the image processing apparatus 12 can be also the configuration illustrated in FIG. 3. Furthermore, the processing of the image processing apparatus 12 can be processing based on the flowchart illustrated in FIG. 6. Here, the configuration and processing of the image processing apparatus 12, which have been described above, will be omitted.

Furthermore, the face orientation can be detected by applying the processing based on the flowchart illustrated in FIG. 8 or by using a deep learning technology. The description will be continued on the assumption that three directions of upward, horizontal, and downward are detected as the face orientation.

<Hand Orientation Determination Processing>

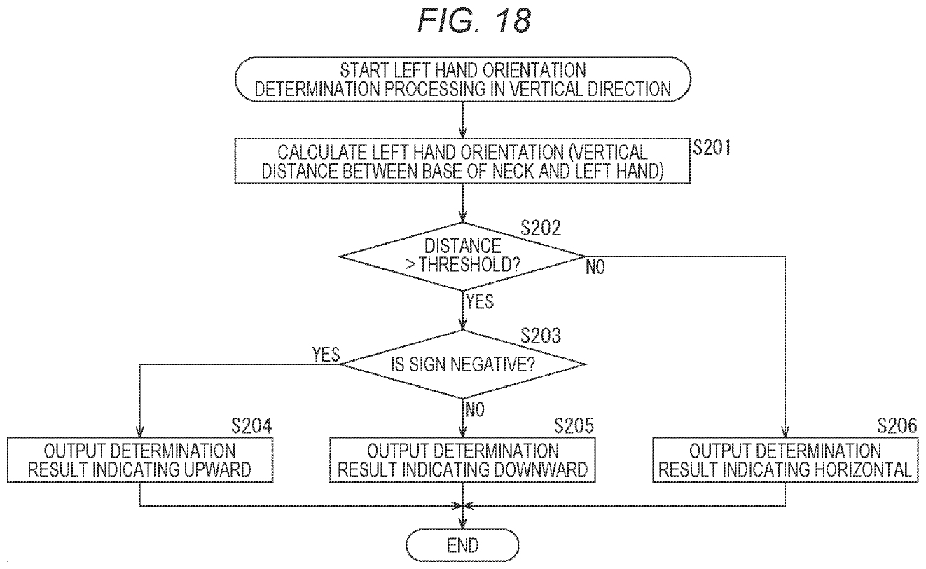

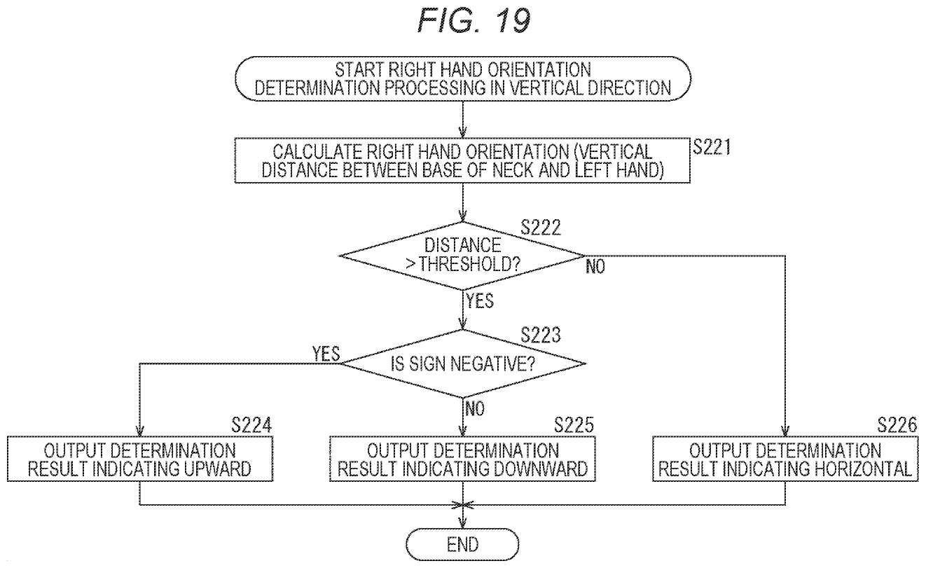

The processing of the hand direction determiner 34 will be additionally described with reference to a flowchart illustrated in each of FIGS. 18 and 19. Since the hand direction determiner 34 performs determination processing on each of the left hand and the right hand, the determination of the orientation of the left hand will be additionally described in the flowchart in FIG. 18.

In step S201, the hand orientation is calculated. As described with reference to FIG. 17, the hand orientation is obtained by calculating the distance between the base of the neck and the wrist of the left hand in the vertical direction.

It is determined in step S202 whether or not an absolute value of the distance calculated in step S201 is equal to or larger than a predetermined threshold. In a case where it is determined in step S202 that distance>threshold is satisfied, the processing proceeds to step S203.

In step S203, it is determined whether or not the sign of the distance y is negative (minus). In a case where it is determined in step S203 that the sign of the distance y is negative, the processing proceeds to step S204.

In a case where the sign of the distance y is negative, the left hand of the subject 2 faces in the upper direction as described with reference to FIG. 17. Therefore, in step S204, a determination result indicating that the left hand of the subject 2 is upward is output. This determination result is supplied to the in-frame direction decider 35 as a hand direction determination result.

On the other hand, in a case where it is determined in step S203 that the sign of the distance y is not negative, or in other words, in a case where it is determined that the sign of the distance y is positive (plus), the processing proceeds to step S205. In a case where the sign of the distance y is positive, the left hand of the subject 2 faces in the lower direction as described with reference to FIG. 17. Therefore, in step S205, a determination result indicating that the left hand of the subject 2 is downward is output. This determination result is supplied to the in-frame direction decider 35 as a hand direction determination result.

On the other hand, in a case where it is determined in step S202 that distance>threshold is not satisfied, the processing proceeds to step S206. In a case where an absolute value of the distance y is smaller than the threshold, it is determined that the left hand of the subject 2 faces in the horizontal direction. In step S206, a determination result indicating that the left hand of the subject 2 is in the horizontal direction is output. This determination result is supplied to the in-frame direction decider 35 as a hand direction determination result.

In such a manner, the direction in which the left hand faces is determined.

The processing regarding the determination of the direction in which the right hand faces will be additionally described with reference to the flowchart illustrated in FIG. 19.

The processing regarding the determination of the direction in which the right hand faces is basically similar to the processing regarding determination of the direction in which the left hand faces as described with reference to FIG. 18, and thus the description of the processing will be omitted. However, the processing regarding the determination of the direction in which the right hand faces is different in that the distance between the base of the neck and the right hand (right wrist) in the vertical direction is calculated in step S221 to calculate the orientation of the right hand, and the subsequent processing is performed on the calculated orientation of the right hand.

Regarding the hand orientation, any of the three directions of upward, horizontal, or downward is output as a determination result, but a plurality of thresholds may be provided, and a plurality of directions (three or more directions) may be output as a determination result.

<Processing of In-Frame Direction Decider>

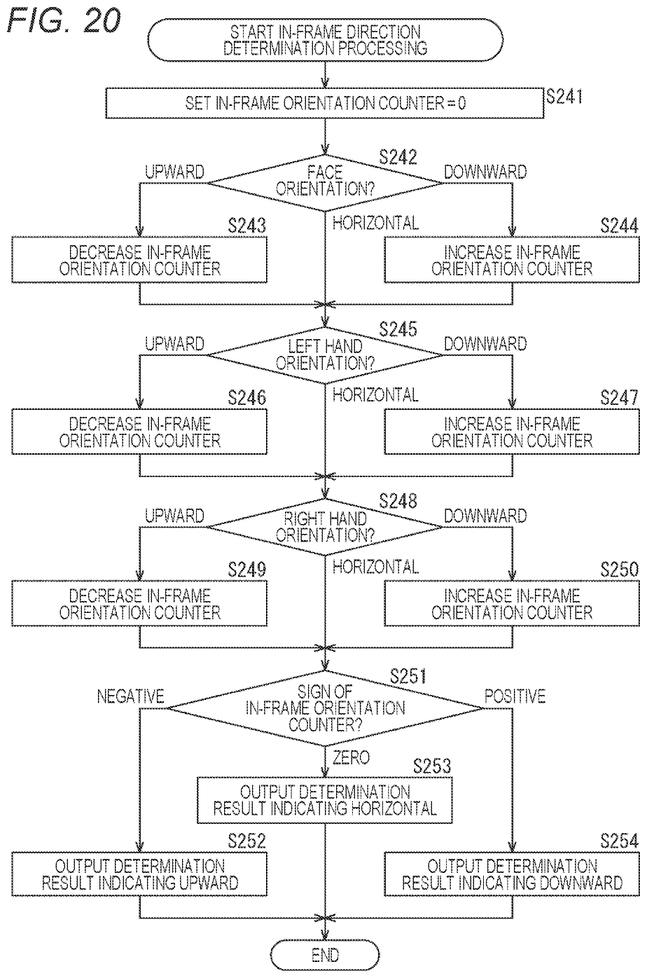

The processing performed by the in-frame direction decider 35 will be described with reference to a flowchart in FIG. 20. The in-frame direction decider 35 acquires a face direction determination result generated by the face direction determiner 33 executing the processing described above and a left hand direction determination result and a right hand direction determination result generated by the hand direction determiner 34 executing the processing described above. Then, when these determination results are acquired, the in-frame direction decider 35 starts the processing of the flowchart illustrated in FIG. 20.

In step S241, the in-frame orientation counter is set to 0.

In step S242, it is determined whether the face orientation of the subject 2 indicated by the supplied face direction determination result is upward, horizontal, or downward.

In a case where it is determined in step S242 that the face orientation of the subject 2 indicated by the face direction determination result is upward, the processing proceeds to step S243. In step S243, the value of the in-frame orientation counter is decreased. After the subtraction, the processing proceeds to step S245.

In a case where it is determined in step S242 that the face orientation of the subject 2 indicated by the face direction determination result is horizontal, the processing proceeds to step S245. In this case, the value of the in-frame orientation counter is maintained.

In a case where it is determined in step S242 that the face orientation of the subject 2 indicated by the face direction determination result is downward, the processing proceeds to step S244. In step S244, the value of the in-frame orientation counter is increased. After the addition, the processing proceeds to step S245.

In step S245, it is determined whether the orientation of the left hand of the subject 2 indicated by the supplied left hand direction determination result is upward, horizontal, or downward.

In a case where it is determined in step S245 that the orientation of the left hand of the subject 2 indicated by the left hand direction determination result is upward, the processing proceeds to step S246. In step S246, the value of the in-frame orientation counter is decreased. After the subtraction, the processing proceeds to step S248.

In a case where it is determined in step S245 that the orientation of the left hand of the subject 2 indicated by the left hand direction determination result is horizontal, the processing proceeds to step S248. In this case, the value of the in-frame orientation counter is maintained.

In a case where it is determined in step S245 that the orientation of the left hand of the subject 2 indicated by the left hand direction determination result is downward, the processing proceeds to step S247. In step S247, the value of the in-frame orientation counter is increased. After the addition, the processing proceeds to step S248.

In step S248, it is determined whether the orientation of the right hand of the subject 2 indicated by the supplied right hand direction determination result is upward, horizontal, or downward.

In a case where it is determined in step S248 that the orientation of the right hand of the subject 2 indicated by the right hand direction determination result is upward, the processing proceeds to step S249. In step S249, the value of the in-frame orientation counter is decreased. After the subtraction, the processing proceeds to step S251.

In a case where it is determined in step S248 that the orientation of the right hand of the subject 2 indicated by the right hand direction determination result is horizontal, the processing proceeds to step S251. In this case, the value of the in-frame orientation counter is maintained.

In a case where it is determined in step S248 that the orientation of the right hand of the subject 2 indicated by the right hand direction determination result is downward, the processing proceeds to step S250. In step S250, the value of the in-frame orientation counter is increased. After the addition, the processing proceeds to step S251.

In step S251, it is determined whether a sign of the in-frame orientation counter is negative (minus), 0, or positive (plus).

In a case where it is determined in step S251 that the sign of the in-frame orientation counter is negative (minus), the processing proceeds to step S252. In step S252, the determination result indicating upward is output to the inter-frame direction decider 36 as the in-frame direction determination result.

In a case where it is determined in step S251 that the sign of the in-frame orientation counter is 0, the processing proceeds to step S253. In step S253, the determination result indicating horizontal is output to the inter-frame direction decider 36 as the in-frame direction determination result.

In a case where it is determined in step S251 that the sign of the in-frame orientation counter is positive (plus), the processing proceeds to step S254. In step S254, the determination result indicating downward is output to the inter-frame direction decider 36 as the in-frame direction determination result.

In such a manner, the direction in which the subject 2 faces in the frame in the vertical direction is determined.

<Processing of Inter-Frame Direction Decider>

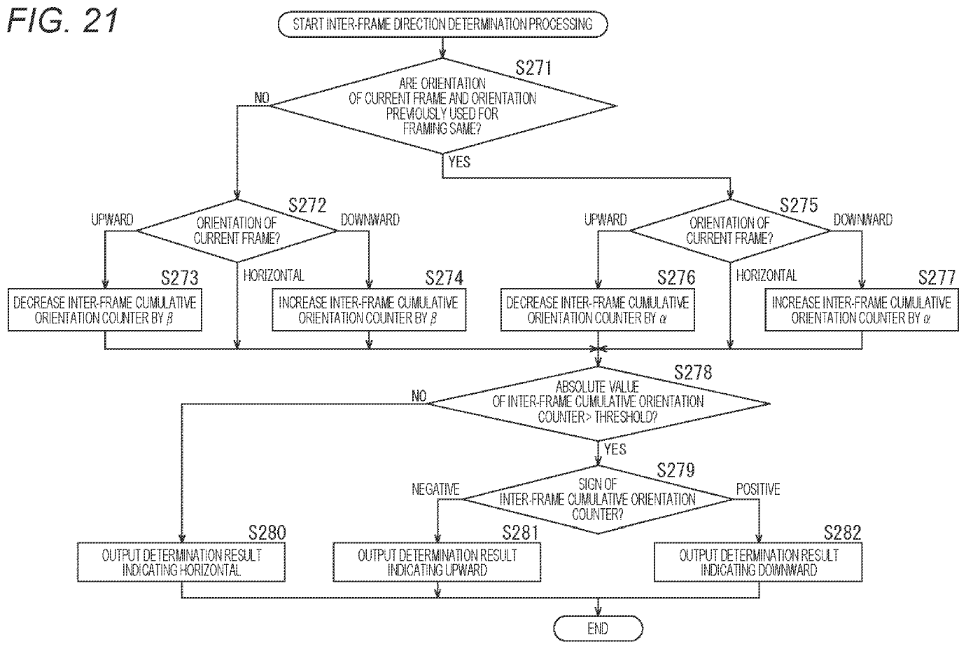

The processing performed by the inter-frame direction decider 36 will be described with reference to a flowchart in FIG. 21. The inter-frame direction decider 36 acquires the in-frame direction determination result generated by executing the processing described above by the in-frame direction decider 35. Then, when the in-frame direction determination result is acquired, the inter-frame direction decider 36 starts the processing of the flowchart illustrated in FIG. 21.

In step S271, it is determined whether or not the current orientation of the frame is the same as an orientation previously used for framing. In a case where it is determined in step S271 that the current orientation of the frame is not the same as the orientation previously used for framing, the processing proceeds to step S272.

In step S272, it is determined whether the orientation of the current frame (the orientation indicated by the in-frame direction determination result) is upward, horizontal, or downward. In a case where it is determined in step S272 that the orientation of the current frame is upward, the processing proceeds to step S273. In step S273, a value of an inter-frame cumulative orientation counter is decreased by β. After the subtraction, the processing proceeds to step S278.

In a case where it is determined in step S272 that the orientation of the current frame is horizontal, the processing proceeds to step S278. In this case, the value of the inter-frame cumulative orientation counter is maintained.

In a case where it is determined in step S272 that the orientation of the current frame is downward, the processing proceeds to step S274. In step S274, a value of an inter-frame orientation counter is increased by the coefficient β. After the addition, the processing proceeds to step S278.

On the other hand, in a case where it is determined in step S271 that the current orientation of the frame is the same as the orientation previously used for framing, the processing proceeds to step S275. In step S275, it is determined whether the orientation of the current frame (the orientation indicated by the in-frame direction determination result) is upward, horizontal, or downward.

In a case where it is determined in step S275 that the orientation of the current frame is upward, the processing proceeds to step S276. In step S276, a value of an inter-frame cumulative orientation counter is decreased by the coefficient α. After the subtraction, the processing proceeds to step S278.

In a case where it is determined in step S275 that the orientation of the current frame is horizontal, the processing proceeds to step S278. In this case, the value of the inter-frame cumulative orientation counter is maintained.

In a case where it is determined in step S275 that the orientation of the current frame is downward, the processing proceeds to step S277. In step S277, a value of an inter-frame orientation counter is increased by the coefficient α. After the addition, the processing proceeds to step S278.

In step S278, it is determined whether or not an absolute value of the inter-frame cumulative orientation counter is larger than a threshold. In a case where it is determined in step S278 that the absolute value of the inter-frame cumulative orientation counter is smaller than the threshold, the processing proceeds to step S280. In step S280, the inter-frame direction determination result indicating that the direction in which the subject 2 faces is horizontal is output to the framing unit 37.

On the other hand, in a case where it is determined in step S278 that the absolute value of the inter-frame cumulative orientation counter is larger than the threshold, the processing proceeds to step S279. In step S279, it is determined whether a sign of the inter-frame cumulative orientation counter is negative or positive.

In a case where it is determined in step S279 that the sign of the inter-frame cumulative orientation counter is negative, the processing proceeds to step S281. In step S281, the inter-frame direction determination result indicating that the direction in which the subject 2 faces is upward is output to the framing unit 37.

On the other hand, in a case where it is determined in step S279 that the sign of the inter-frame cumulative orientation counter is positive, the processing proceeds to step S282. In step S282, the inter-frame direction determination result indicating that the direction in which the subject 2 faces is downward is output to the framing unit 37.

In such a manner, the direction in which the subject 2 used for framing faces is finally decided. The framing unit 37 performs framing based on the inter-frame direction determination result from the inter-frame direction decider 36.

In a case where it is determined that the orientation of the subject 2 is above, the framing unit 37 performs framing for making a space above. In addition, in a case where it is determined that the orientation of the subject 2 is below, the framing unit 37 performs framing for making a space below. Furthermore, in a case where it is determined that the orientation of the subject 2 is horizontal, the framing unit 37 performs framing for making a space in the horizontal direction or framing for maintaining framing at that time point.

Note that, in a case where it is determined that the orientation of the subject 2 is below, framing for maintaining framing at that time point may be performed. There is a high possibility that a posture in which a hand of the subject 2 faces toward the lower side is a normal posture instead of intentionally facing the hand toward the lower side. In such a case where a hand is located at a position of the hand not intended by the subject 2, framing in consideration of the hand orientation may not be performed.

On the other hand, when the subject 2 moves the hand horizontally or at a position higher than a horizontal position, that is, above, it can be estimated that the motion of the hand is intended by the subject 2 and is a significant motion. Therefore, when it is determined that the hand orientation of the subject 2 is horizontal or upward, the orientation may be used as a significant orientation for changing a composition of framing.

Note that, since the horizontal direction is the left-right direction, when it is determined that the hand orientation is the horizontal direction, the orientation of the hand in the left-right direction may be used as the orientation for changing the composition of framing.

The determination of the direction in which the subject 2 faces in the vertical direction described herein and the determination of the direction in which the subject 2 faces in the horizontal direction described above can be applied in combination. That is, it is also possible to determine which one of four directions including the upper direction, the lower direction, the left direction, and the right direction (five directions including frontward) as the direction in which the subject 2 faces. In this case, framing can be performed in an oblique direction such as an upper left direction or an upper right direction.

<Another Configuration Example of Image Processing Apparatus>

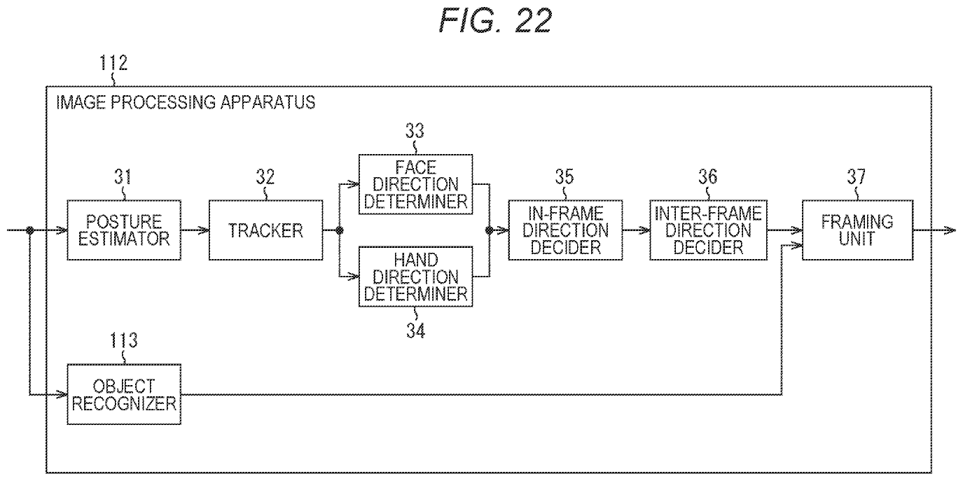

FIG. 22 is a diagram illustrating another configuration example of the image processing apparatus 12. An image processing apparatus 112 illustrated in FIG. 22 has a similar configuration to the configuration of the image processing apparatus 12 illustrated in FIG. 3 except that an object recognizer 113 is added to the image processing apparatus 12 illustrated in FIG. 3. Description of portions having a similar configuration to the configuration of the image processing apparatus 12 illustrated in FIG. 3 will be redundant, and thus will be omitted.

An image captured by the camera 11 (FIG. 2) is supplied to the posture estimator 31 and the object recognizer 113 of the image processing apparatus 112. The object recognizer 131 performs object recognition and supplies a recognition result to the framing unit 37. It is, for example, a type of the object, position information of the object, and the like that is supplied to the framing unit 37 as the recognition result.

The object recognizer 131 performs object recognition using, for example, a deep learning technology.

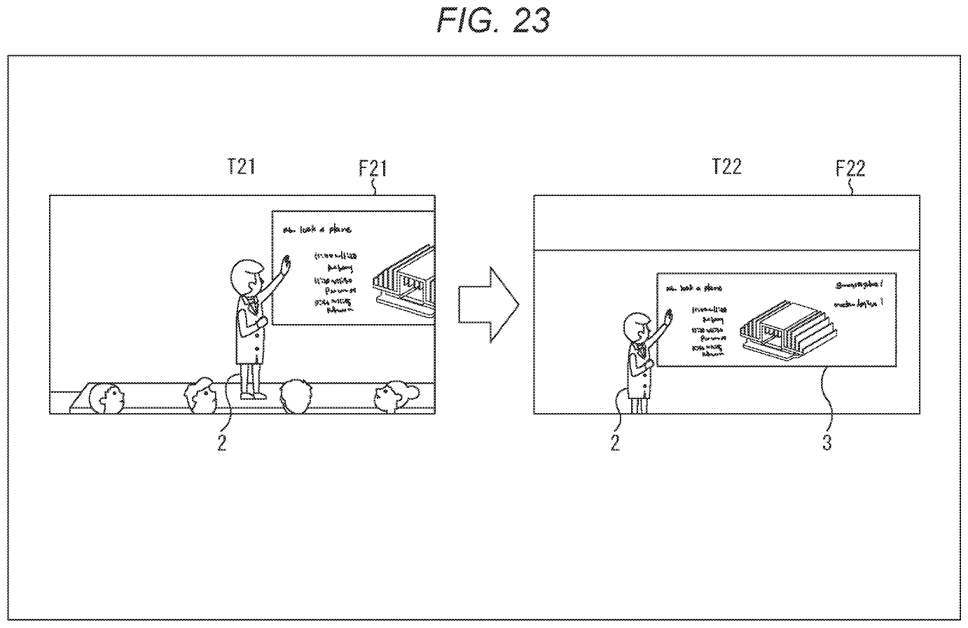

Framing in a case where the image processing apparatus 112 includes the object recognizer 113 and performs framing by using the object recognition result will be described with reference to FIG. 23.

In a frame F21 captured at time T21, the subject 2 faces in the upper right direction in the drawing. The frame F21 shown at time T21 in FIG. 23 is the same image as the frame F11 shown at time T11 in FIG. 16.

Referring to FIG. 16 again, in a case where the orientation of the subject 2 is determined in the frame F11 in which framing is performed at time T11, and it is determined that the orientation of the subject 2 is upward, the composition of framing is changed at time T12, and an image like the frame F12 is obtained. The frame F12 is in a state in which the right side of the screen 3 is not fully visible.

In a case where the object recognizer 113 of the image processing apparatus 112 recognizes the screen 3 as an object and framing is performed in consideration of the recognition result, it is possible to obtain a frame F22 as illustrated at time T22 in FIG. 23. In the frame F22, the entire screen 3 is shown.

In this case, the screen 3 is recognized by object recognition, and the composition of framing is set such that the screen 3 fits within the frame F22. Furthermore, in the case of the frame F22, it is determined that the subject 2 faces in the right direction, and the screen 3 recognized as an object exists in the right direction. Therefore, a composition is set such that the entire screen 3 fits within the frame.

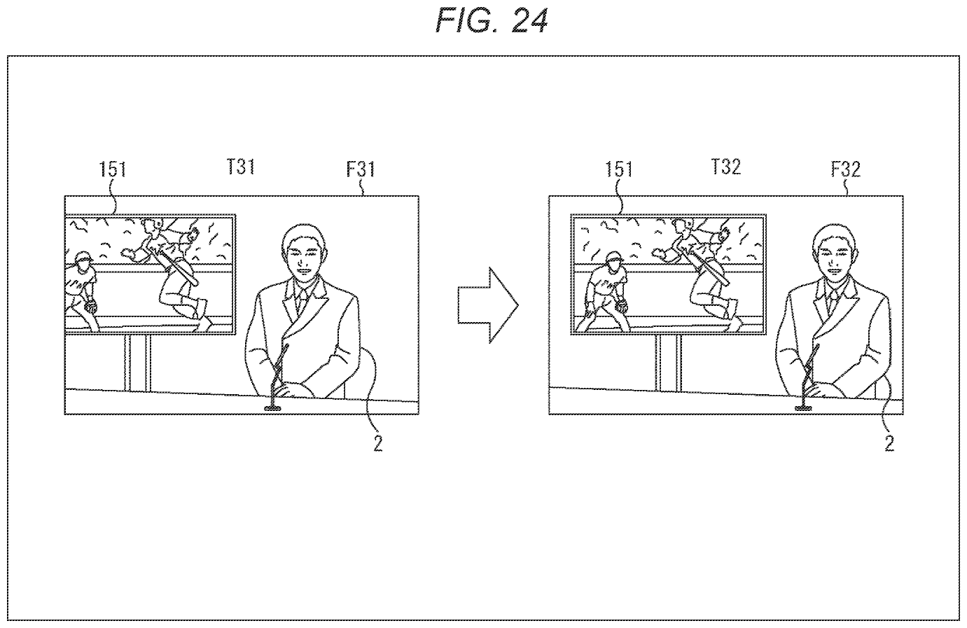

FIG. 24 is a diagram illustrating another example of a case where framing is performed by using a result of object recognition. At time T31, a frame F31 is obtained as a result of framing. In the frame F31, the subject 2 and a display 151 are shown. In the frame F31, the display 151 is not fully visible.

The object recognition is performed and the display 151 is recognized as an object, and then, framing is performed such that the entire display 151 is displayed. As a result, a frame F32 is obtained at a time T32. In the frame F32, the entire display 151 are displayed.

<Processing of Image Processing Apparatus>

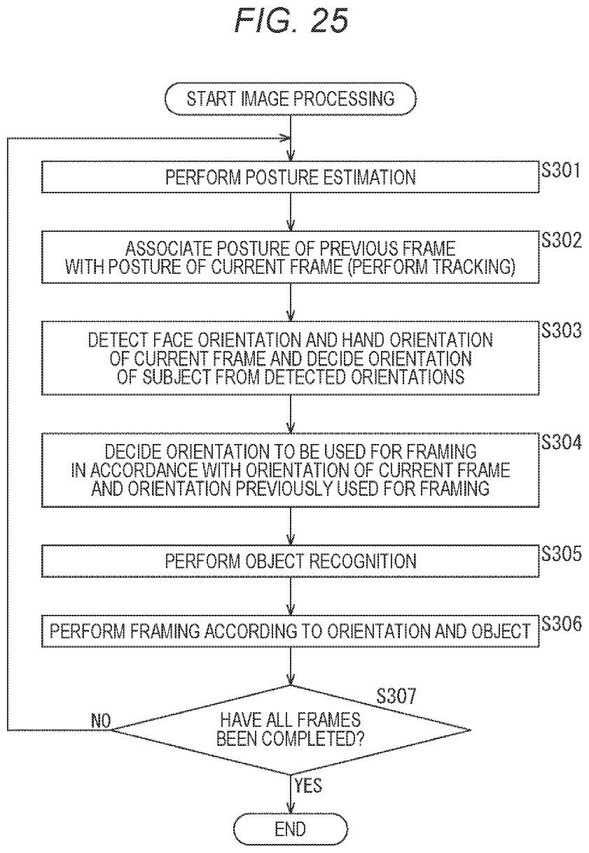

Processing of the image processing apparatus 112 illustrated in FIG. 22 will be described with reference to a flowchart illustrated in FIG. 25.

Since processing of steps S301 to S304 is performed in a similar manner to steps S11 to S15 (FIG. 6), the description of the processing will be omitted. That is, also in the image processing apparatus 112 illustrated in FIG. 22, processing executed in each unit of the posture estimator 31 to the inter-frame direction decider 36 is performed in a similar manner to the processing executed in each unit of the posture estimator 31 to the inter-frame direction decider 36 of the image processing apparatus 12 illustrated in FIG. 2.

In step S305, the object recognizer 113 performs object recognition. This object recognition is, for example, processing of detecting a predetermined object or detecting a position of the object by using a deep learning technology.

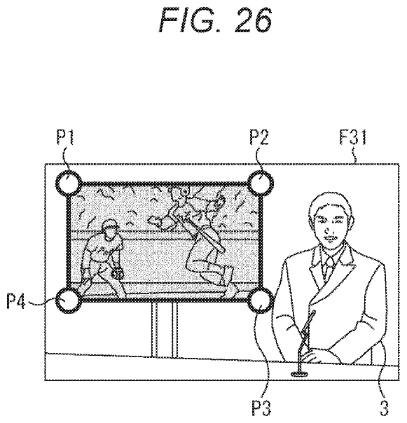

The object recognition may be performed by designating an object by a user. For example, as illustrated in FIG. 26, a mechanism may be provided in which the display 151 is recognized as an object when the user designates four corners P1, P2, P3, and P4 of the display 151 while the frame F31 is displayed.

In such a manner, in a case where an object to be recognized is instructed by the user, even an object that is not recognized as an object can be recognized. For example, in a case where the user wants to display an image displayed in a predetermined region of the display 151 without fail, the user is only required to issue an instruction in advance to set the image as an object to be recognized.

In addition, the object desired to be included in an angle of view may be other than a document, a display, or the like, and an object preset by the user can be recognized. Furthermore, a mechanism for setting what is desired to be included in the angle of view for each presentation or event, or the like may be provided. Moreover, a mechanism may be provided in which a scene being imaged is determined, and the type of the object to be included in the angle of view is set in accordance with the scene.

The recognition result by the object recognizer 113 is supplied to the framing unit 37.

In step S306, the framing unit 37 performs framing in accordance with the orientation of the subject 2 and the object recognized as an object. This framing is, as described with reference to FIGS. 23 and 24, framing having a composition in which not only the orientation of the subject 2 but also an object in the orientation is recognized and the entire object is displayed.

By recognizing an object and performing framing by using the recognition result, framing according to a direction in which the subject 2 faces can be performed, and moreover, framing having a composition in which an object in the direction is displayed so as to be fully visible can be performed. Thus, by performing framing by using not only the orientation of the subject 2 but also the object recognition result, more appropriate framing can be performed.

For example, when an image in which a plurality of displays is shown side by side is captured, a display seen by the subject 2 is specified by the orientation of the subject 2, and framing can be performed in a composition in which the entire display is shown.

<Another System Configuration Example>

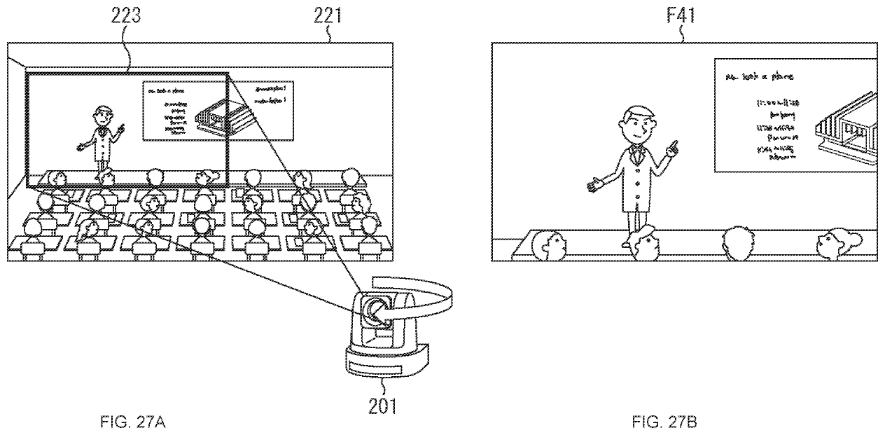

In the above embodiment, it has been described that the image 1 as illustrated in FIG. 1 is captured by the camera 11 (FIG. 2), and framing is performed by setting a region cut out from the image 1. As another example, as illustrated in FIG. 27, the camera 11 may be a camera 201 capable of panning, tilting, and zooming, and framing may be performed by setting a region to be imaged by the camera 201.

The camera 201 is a camera that images by mechanically panning, tilting, and zooming. It is assumed that the camera 201 is imaging a lecture scene 221 as illustrated in A of FIG. 27. The camera 201 images a region 223 of the lecture scene 221 by mechanically panning, tilting, and zooming.

An image output from the camera 201 is a frame F41 as illustrated in B of FIG. 27. The region 223 imaged by the camera 201 may be configured to be set by the image processing apparatus 12 (or the image processing apparatus 112).

In a case of such a configuration, not only a video from the camera 201 is supplied to the image processing apparatus 12, but also a control signal for controlling framing of the camera 201 is transmitted to and received from the image processing apparatus 12, a status is returned from the camera 201 to the image processing apparatus 12, and the camera 201 and the image processing apparatus 12 are connected so as to be able to communicate with each other.

As described above, the present technology can also be applied to a case where framing is performed by controlling the camera 201.

In the present technology, it is possible to comprehensively determine the orientation of the subject by considering the orientations of a plurality of body parts of the subject and continuity and change in a time direction. Furthermore, the composition can be decided and transitioned in accordance with the determined orientation of the subject, and appropriate framing that is smooth and does not fail to catch up with motion of the subject can be performed.

<Recording Medium>

The above series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

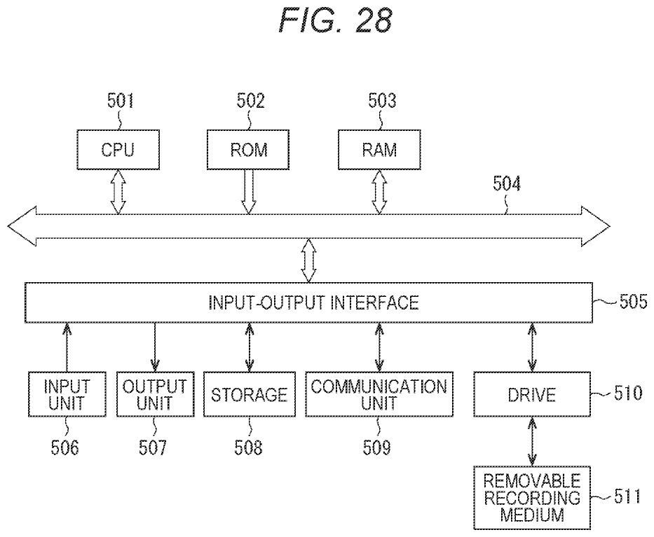

FIG. 28 is a block diagram illustrating a configuration example of hardware of a computer that executes the above series of processing by a program. In the computer, a central processing unit (CPU) 501, a read only memory (ROM) 502, and a random access memory (RAM) 503 are mutually connected by a bus 504. An input-output interface 505 is further connected to the bus 504. An input unit 506, an output unit 507, a storage 508, a communication unit 509, and a drive 510 are connected to the input-output interface 505.

The input unit 506 includes a keyboard, a mouse, a microphone, and the like. The output unit 507 includes a display, a speaker, and the like. The storage 508 includes a hard disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, for example, the CPU 501 loads a program stored in the storage 508 into the RAM 503 via the input-output interface 505 and the bus 504 and executes the program, and thus the above series of processing is performed.

The program executed by the computer (CPU 501) can be provided by being recorded in the removable recording medium 511 as a package recording medium or the like, for example. Furthermore, the program can be provided via a wired or wireless transmission medium such as a local area network, the Internet, or digital satellite broadcasting.

In the computer, the program can be installed in the storage 508 via the input-output interface 505 by attaching the removable recording medium 511 to the drive 510. In addition, the program can be received by the communication unit 509 via a wired or wireless transmission medium and installed in the storage 508. Alternatively, the program can be installed in the ROM 502 or the storage 508 in advance.

Note that the program executed by the computer may be a program in which processing is performed in time series in the order herein described, or may be a program in which processing is performed in parallel or at necessary timing such as when a call is made.

Furthermore, the system herein represents a device as a whole including a plurality of devices.

Note that the effects herein described are merely examples and are not limited, and furthermore, other effects may be obtained.

Note that the embodiment of the present technology is not limited to the above-described embodiment, and various modifications can be made without departing from the gist of the present technology.

Note that the present technology can have the following configurations.

(1) An image processing apparatus including:

a detector that detects a face and a predetermined part of a subject in a captured image;

a face direction determiner that determines a direction in which the face detected by the detector faces;

a part direction determiner that determines a direction in which the predetermined part detected by the detector faces; and

a first direction decider that decides a direction in which the subject faces by using a determination result by the face direction determiner and a determination result by the part direction determiner.

(2) The image processing apparatus according to (1), in which

the detector detects at least two or more parts other than the face as the predetermined part,

the part direction determiner determines a direction of each of the two or more parts, and

the first direction decider decides the direction in which the subject faces by using determination results of three or more parts including the face.

(3) The image processing apparatus according to (2), in which

the first direction decider decides the direction in which the subject faces on the basis of a counter value obtained by adding or subtracting a value corresponding to each of the determination results of the three or more parts.

(4) The image processing apparatus according to (3), in which

in a case where the counter value is 0, it is determined that the subject faces frontward.

(5) The image processing apparatus according to any of (1) to (4), in which

the face direction determiner calculates a distance between a position of a neck and a position of a nose of the subject, and determines that the face faces frontward in a case where the distance is smaller than a predetermined threshold.

(6) The image processing apparatus according to any of (1) to (5), in which

the detector detects a hand of the subject as the predetermined part, and

the part direction determiner calculates a distance between a position of a neck and a position of the hand of the subject, and determines that the hand faces frontward in a case where the distance is smaller than a predetermined threshold.

(7) The image processing apparatus according to any of (1) to (6), further including

a second direction decider that decides an orientation of the subject in a plurality of captured images by using a first direction decided by the first direction decider and a second direction decided by processing a plurality of captured images processed before a captured image set as a processing target by the first direction decider.

(8) The image processing apparatus according to (7), in which

the second direction decider

decides the direction in which the subject faces on the basis of a cumulative value obtained by adding or subtracting a predetermined coefficient depending on whether or not the first direction and the second direction coincide with each other.

(9) The image processing apparatus according to (8), in which

whether to add or subtract the predetermined coefficient is decided on the basis of the first direction.

(10) The image processing apparatus according to (8) or (9), in which

a first coefficient added to or subtracted from the cumulative value when the first direction and the second direction coincide with each other is smaller than a second coefficient added to or subtracted from the cumulative value when the first direction and the second direction do not coincide with each other.

(11) The image processing apparatus according to any of (8) to (10), in which

in a case where the cumulative value is smaller than a predetermined threshold, it is decided that the subject faces frontward.

(12) The image processing apparatus according to any of (8) to (11), in which

the plurality of captured images is a predetermined number of captured images set as a processing target at a time point before the captured image set as a processing target by the first direction decider, and

the cumulative value is a weighted value according to time from the captured image set as the processing target.

(13) The image processing apparatus according to any of (8) to (12), further including

a framing unit that performs framing on the basis of the orientation of the subject decided by the second direction decider.

(14) The image processing apparatus according to (13), in which

the framing unit sets a composition in which an image region in a direction in which the subject faces is larger.

(15) The image processing apparatus according to (13) or (14), further including

an object recognizer that performs object recognition on the captured image, in which

the framing unit performs framing on the basis of the orientation of the subject decided by the second direction decider and a recognition result by the object recognizer.

(16) The image processing apparatus according to (15), in which

the framing unit sets a composition including an object in the direction in which the subject faces, the object being recognized by the object recognition.

(17) The image processing apparatus according to any of (7) to (16), in which

the second direction decider decides any of leftward, frontward, rightward, upward, or downward as the direction in which the subject faces.

(18) The image processing apparatus according to any of (1) to (17), in which

the face direction determiner determines the direction in which the face faces by applying a deep learning technology.

(19) An image processing method including:

by an image processing apparatus,

detecting a face and a predetermined part of a subject in a captured image;

determining a direction in which the face having been detected faces;

determining a direction in which the predetermined part having been detected faces; and

deciding a direction in which the subject faces on the basis of the direction having been determined in which the face faces and the direction having been determined in which the predetermined part faces.

(20) A computer-readable recording medium that records a program that causes a computer to execute steps of

detecting a face and a predetermined part of a subject in a captured image,

determining a direction in which the face having been detected faces,

determining a direction in which the predetermined part having been detected faces, and

deciding a direction in which the subject faces on the basis of the direction having been determined in which the face faces and the direction having been determined in which the predetermined part faces.

### REFERENCE SIGNS LIST

1 Image
2 Subject
3 Screen
6 Inter-frame direction decider
10 Image processing system
11 Camera
12 Image processing apparatus
13 Display
14 Recorder
31 Posture estimator
32 Tracker
33 Face direction determiner
34 Hand direction determiner
35 In-frame direction decider
36 Inter-frame direction decider
37 Framing unit
112 Image processing apparatus
113 Object recognizer
131 Object recognizer
133 Step
151 Display
201 Camera
221 Lecture scene
223 Region

1. An image processing apparatus comprising:
a detector that detects a face and a predetermined part of a subject in a captured image;
a face direction determiner that determines a direction in which the face detected by the detector faces;
a part direction determiner that determines a direction in which the predetermined part detected by the detector faces; and
a first direction decider that decides a direction in which the subject faces by using a determination result by the face direction determiner and a determination result by the part direction determiner.

2. The image processing apparatus according to claim 1, wherein
the detector detects at least two or more parts other than the face as the predetermined part,
the part direction determiner determines a direction of each of the two or more parts, and
the first direction decider decides the direction in which the subject faces by using determination results of three or more parts including the face.

3. The image processing apparatus according to claim 2, wherein
the first direction decider decides the direction in which the subject faces on a basis of a counter value obtained by adding or subtracting a value corresponding to each of the determination results of the three or more parts.

4. The image processing apparatus according to claim 3, wherein
in a case where the counter value is 0, it is determined that the subject faces frontward.

5. The image processing apparatus according to claim 1, wherein
the face direction determiner calculates a distance between a position of a neck and a position of a nose of the subject, and determines that the face faces frontward in a case where the distance is smaller than a predetermined threshold.

6. The image processing apparatus according to claim 1, wherein
the detector detects a hand of the subject as the predetermined part, and
the part direction determiner calculates a distance between a position of a neck and a position of the hand of the subject, and determines that the hand faces frontward in a case where the distance is smaller than a predetermined threshold.

7. The image processing apparatus according to claim 1, further comprising
a second direction decider that decides an orientation of the subject in a plurality of captured images by using a first direction decided by the first direction decider and a second direction decided by processing a plurality of captured images processed before a captured image set as a processing target by the first direction decider.

8. The image processing apparatus according to claim 7, wherein
the second direction decider
decides the direction in which the subject faces on a basis of a cumulative value obtained by adding or subtracting a predetermined coefficient depending on whether or not the first direction and the second direction coincide with each other.

9. The image processing apparatus according to claim 8, wherein
whether to add or subtract the predetermined coefficient is decided on a basis of the first direction.

10. The image processing apparatus according to claim 8, wherein
a first coefficient added to or subtracted from the cumulative value when the first direction and the second direction coincide with each other is smaller than a second coefficient added to or subtracted from the cumulative value when the first direction and the second direction do not coincide with each other.

11. The image processing apparatus according to claim 8, wherein
in a case where the cumulative value is smaller than a predetermined threshold, it is decided that the subject faces frontward.

12. The image processing apparatus according to claim 8, wherein
the plurality of captured images is a predetermined number of captured images set as a processing target at a time point before the captured image set as a processing target by the first direction decider, and
the cumulative value is a weighted value according to time from the captured image set as the processing target.

13. The image processing apparatus according to claim 8, further comprising
a framing unit that performs framing on a basis of the orientation of the subject decided by the second direction decider.

14. The image processing apparatus according to claim 13, wherein
the framing unit sets a composition in which an image region in a direction in which the subject faces is larger.

15. The image processing apparatus according to claim 13, further comprising
an object recognizer that performs object recognition on the captured image, wherein
the framing unit performs framing on a basis of the orientation of the subject decided by the second direction decider and a recognition result by the object recognizer.

16. The image processing apparatus according to claim 15, wherein
the framing unit sets a composition including an object in the direction in which the subject faces, the object being recognized by the object recognition.

17. The image processing apparatus according to claim 7, wherein
the second direction decider decides any of leftward, frontward, rightward, upward, or downward as the direction in which the subject faces.

18. The image processing apparatus according to claim 1, wherein
the face direction determiner determines the direction in which the face faces by applying a deep learning technology.

19. An image processing method comprising:
by an image processing apparatus,
detecting a face and a predetermined part of a subject in a captured image;
determining a direction in which the face having been detected faces;
determining a direction in which the predetermined part having been detected faces; and
deciding a direction in which the subject faces on a basis of the direction having been determined in which the face faces and the direction having been determined in which the predetermined part faces.

20. A computer-readable recording medium that records a program that causes a computer to execute steps of
detecting a face and a predetermined part of a subject in a captured image,
determining a direction in which the face having been detected faces,
determining a direction in which the predetermined part having been detected faces, and
deciding a direction in which the subject faces on a basis of the direction having been determined in which the face faces and the direction having been determined in which the predetermined part faces.
